(19) United States
(12) Patent Application Publication
(10) Pub. No.: US 2017/0333854 A1
(43) Pub. Date: Nov. 23, 2017

(54) DISPERSING DEVICE AND A METHOD FOR DISPERSING

(71) Applicant: SINTOKOGIO, LTD, Aichi (JP)

(72) Inventors: Yuu ISHIDA, Aichi (JP); Katsuaki ODAGI, Aichi (JP); Koji KAJITA, Aichi (JP); Yutaka HAGATA, Aichi (JP)

(73) Assignee: SINTOKOGIO, LTD, Aichi (JP)

(21) Appl. No.: 15/525,877

(22) PCT Filed: Aug. 25, 2015
(86) PCT No.: PCT/JP2015/073873

§ 371 Date: May 10, 2017

(30) Foreign Application Priority Data
Nov. 25, 2014 (JP) 2014-237740

(51) Int. Cl. B01F 7/00; B01F 3/12; B01F 15/06; B01F 15/02; B01F 15/00

(52) U.S. Cl. CPC B01F 7/00825; B01F 15/065; B01F 7/00833; B01F 15/0222; B01F 3/1221; B01F 15/0237; B01F 2003/125; B01F 2015/0011; B01F 2015/061

(57) ABSTRACT

A dispersing device is provided by which a dispersion with a high yield and a proper dispersing process can be carried out. The dispersing device causes a mixture of a slurry or a liquid to flow by centrifugal force toward an outer circumference between a rotor and a stator. It comprises a container, a cover assembly that closes an upper opening of the container, a stator that is fixed under the cover assembly, a rotor that is disposed to face a lower surface of the stator, and an assembly for supplying the mixture that stores an unprocessed mixture to be supplied to a gap between the rotor and the stator. The assembly for supplying the mixture has a body, a first member for injecting the mixture, and a second member for injecting the mixture.

### TECHNICAL FIELD

The present invention relates to a dispersing device and a method for dispersing to disperse substances in a mixture that is a slurry or a liquid.

### BACKGROUND ART

Conventionally, a dispersing device that continuously disperses powdery substances in liquids or slurry has been known. It causes the liquids or slurry to pass through a gap between a rotor that rotates at a high speed and a stator that does not rotate. The powdery substances are dispersed by a shearing force that is generated by the rotation at the high speed (see Patent Literature 1 and Patent Literature 2).

The term “disperse” used herein means to make powdery substances in a slurry finer and to make them be uniformly distributed, to make powdery substances in a slurry be uniformly distributed, or to mix a plurality of liquids to cause them to be homogeneous.

When a conventional dispersing device is used to disperse a viscous mixture, the mixture may be retained inside the dispersing device or a piping so that the yield deteriorates. Since some of the mixture to be processed by the dispersing device is expensive, a need to improve the yield exists. Further, a need to properly disperse exists.

### PRIOR-ART PUBLICATIONS

### Patent Literature

### Patent Literature 1:

Japanese Patent Laid-open Publication No. 2000-153167

### Patent Literature 2:

Japanese Patent Laid-open Publication No. 2011-36862

### DISCLOSURE OF INVENTION

### Problems to be Solved by the Invention

The present invention aims to provide a dispersing device and a method for dispersing by which a dispersion with a high yield and a proper disposing process can be achieved.

### Means to Solve the Problems

The dispersing device of the present invention is a shear-type dispersing device. It disperses a mixture of a slurry or a liquid by causing it to flow by centrifugal force toward an outer circumference between a rotor and a stator that is disposed to face the rotor. It comprises a container for receiving the dispersed mixture, a cover assembly that closes an upper opening of the container, a stator that is fixed under the cover assembly, a rotor that is disposed under the stator to face the stator, and an assembly for supplying the mixture that stores an unprocessed mixture to be supplied to a gap between the stator and the rotor. The assembly for supplying the mixture has a body for storing the mixture. It also has a first member for injecting the mixture that injects the mixture that is stored in the body to a supply route, to thereby supply the mixture to the gap between the stator and the rotor. It also has a second member for injecting the mixture that is disposed to protrude from a plane for pressing of the first member for injecting the mixture, and that injects the mixture in the supply route to supply the mixture to the gap between the stator and the rotor.

The method for dispersing of the present invention uses the above-mentioned dispersing device so that the mixture is supplied to the gap between the stator and the rotor to cause the mixture to flow therebetween toward the outer circumference by means of centrifugal force, to thereby be dispersed.

### Advantageous Effects

By the present invention the yield can be improved and a proper dispersing process can be achieved.

### BRIEF DESCRIPTION OF DRAWINGS

FIG. 1 is a schematic sectional view of the dispersing device of the present invention.

FIG. 2 shows schematic sectional views of the dispersing device in FIG. 1. Figure (a) shows a cross section taken along the line A1-A1 in FIG. 3. Figure (b) shows a cross section taken along the line A2-A2 and a cross section taken along the line A3-A3 in FIG. 3.

FIG. 3 illustrates the details of the dispersing device in FIG. 1. Figure (a) shows a cross section taken along the line A4-A4 in FIG. 2. Figure (b) shows a cross section taken along the line A5-A5 in FIG. 2. Figure (c) shows enlarged major parts illustrating a spacer, a labyrinth seal that is located at a second hole for inserting the rotary shaft, and a seal by air purging. Figure (d) shows enlarged major parts illustrating a second spacer. Figure (e) shows enlarged major parts illustrating integration by binding the rotary shaft and the rotor, and the spacer. Figure (f) shows a top view of the spacer.

FIG. 4 illustrates a groove for cooling that is a part of the dispersing device in FIG. 1 and another example of a stator that has a groove. Figure (a) shows another example of a stator that can be used for the dispersing device in FIG. 1, which figure shows a cross section taken along the same position as in. FIG. 3(b). Figure (b) shows yet another example of a stator that can be used for the dispersing device in FIG. 1, which Fig. (b) shows a cross section taken along the same position as in FIG. 3(b). Figure (c) shows a cross section taken along the line A6-A6 in FIG. 4(b).

FIG. 5 illustrates an assembly for supplying the mixture that is a part of the dispersing device in FIG. 5. Figure (a) shows the assembly when the first and second members for injecting the mixture are retracted. Figure (b) shows the assembly when the first member for injecting the mixture pushes out the mixture. Figure (c) shows the assembly when the first member for injecting the mixture pushes out all of the mixture and the first member for injecting the mixture is retracted. Figure (d) shows the assembly when the second member for injecting the mixture pushes out the mixture. Figure (e) shows the assembly when the second member for injecting the mixture pushes out all of the mixture.

FIG. 6 illustrates another example of the container that is a part of the dispersing device in FIG. 1. Figure (a) shows the dispersing device where the container is replaced by a container having an agitating plate. Figure (b) shows the dispersing device where the container is replaced by a container that is combined with a tank for storing the mixture after the process ends.

FIG. 7 is a schematic sectional view of another embodiment of the dispersing device of the present invention.

FIG. 8 shows schematic sectional views of the dispersing device in FIG. 7. Figure (a) shows a cross section taken along the line B1-B1 in FIG. 10. Figure (b) shows a cross section taken along the line B2-B2 and a cross section taken along the line B3-B3 in FIG. 10.

FIG. 9 is a schematic sectional view of the dispersing device in FIG. 7 that is taken along the line B7-B7 in FIG. 10.

FIG. 10 illustrates the details of the dispersing device in FIG. 7. Figure (a) shows a cross section taken along the line B4-B4 in FIG. 8(a). Figure (b) shows a cross section taken along the line B2-B2 in FIG. 10(a) and a part of an enlarged cross section taken along the line B3-B3. Figure (c) shows a part of an enlarged cross section taken along the line B7-B7 in FIG. 10(a).

FIG. 11 is a schematic view of the dispersing system that comprises the dispersing device in FIG. 8 (the dispersing device in FIG. 8, which has no assembly for supplying the mixture).

FIG. 12 is a schematic view of another embodiment of the dispersing system. This embodiment is suitable for a dispersing process that uses multiple paths.

FIG. 13 is a schematic view of yet another embodiment of the dispersing system. This embodiment uses air pressure for supplying the mixture.

FIG. 14 shows schematic views of the dispersing device, where a groove is provided to the rotor at a position that corresponds to the through-hole that is formed in the stator. Figure (a) shows enlarged major parts illustrating the position of the through-hole that is formed in the stator. Figure (b) shows enlarged major parts of the through-hole and the groove that is provided to the rotor. Figure (c) is a plan view illustrating the positional relationship between the groove that is provided to the rotor and the through-hole.

FIG. 15 is a perspective view of the rotor in FIG. 4

### BEST MODE FOR CARRYING OUT THE INVENTION

Below, the shear-type dispersing device of the present invention is discussed with reference to the drawings. The shear-type dispersing device to be discussed circulates and disperses a slurry mixture (called a “solid-liquid dispersion” or “slurrying”) or circulates and disperses a mixture of liquids (called a “liquid-liquid dispersion” or “emulsifying”). The term “disperse” means to make substances in the mixture be uniformly distributed or make them finer and be uniformly distributed. Namely, it means to mix each kind of substance in the mixture so that it is uniformly distributed.

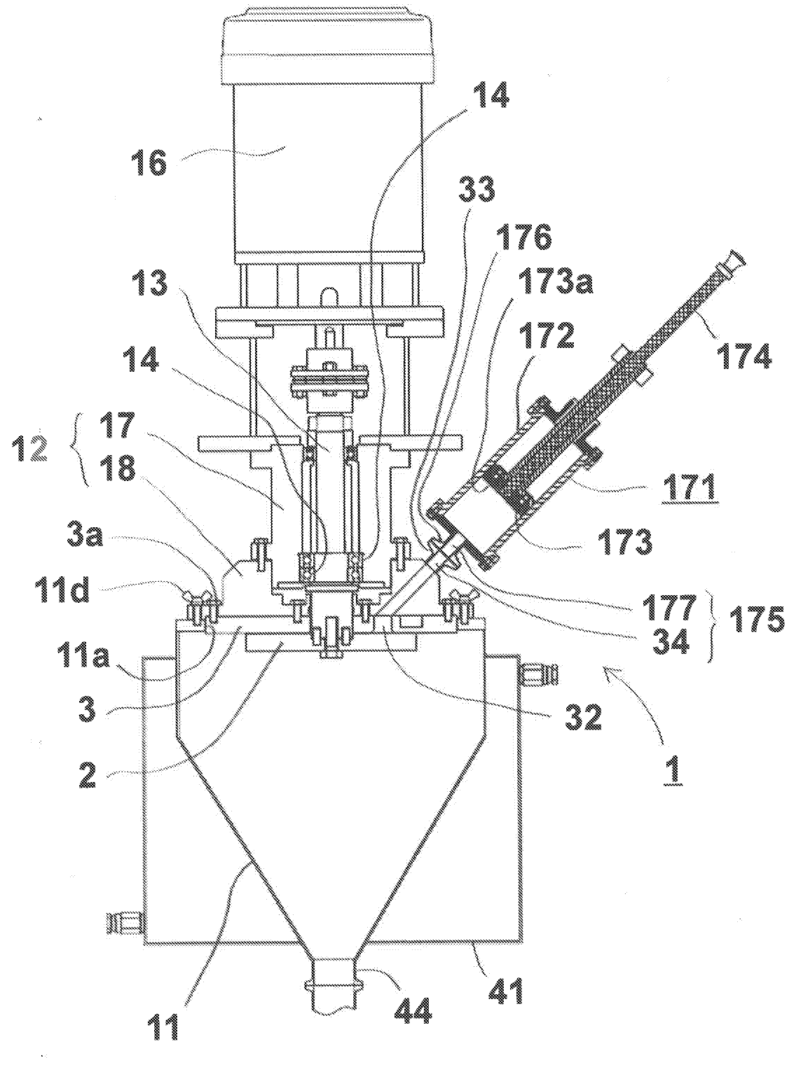

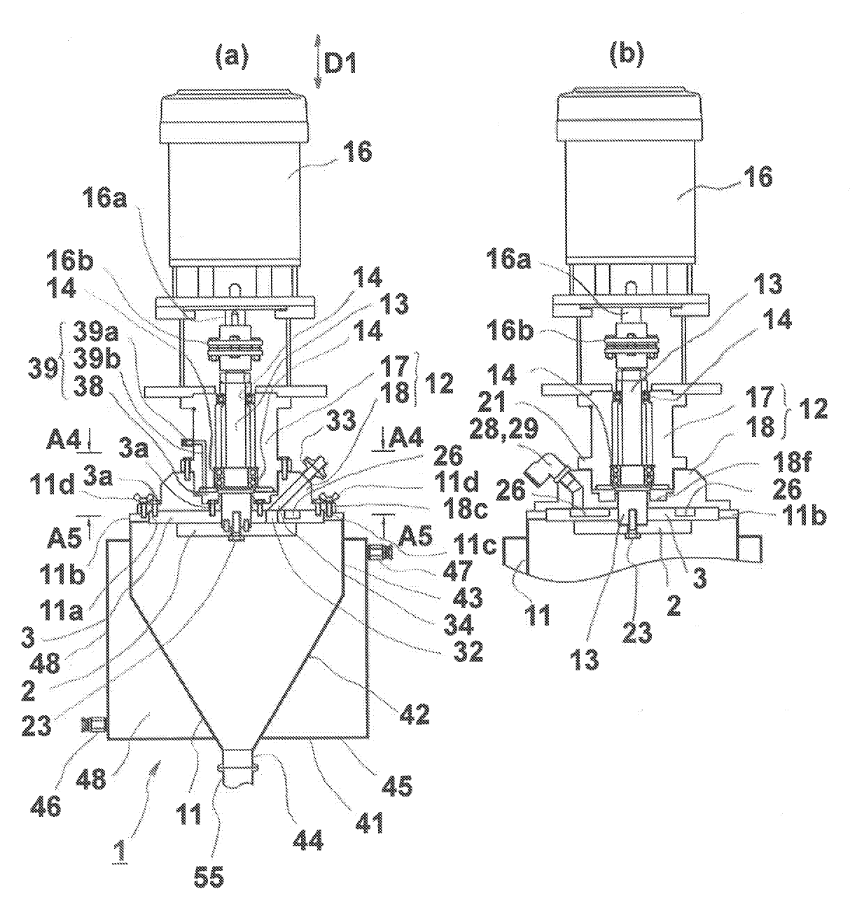

First, the shear-type dispersing device (below, “the dispersing device”) 1 that is shown in FIGS. 1 to 5 is discussed. The dispersing device 1 comprises a rotor 2 and a stator 3 that is disposed to face the rotor 2. It causes a slurry or liquid mixture 4 to flow between the rotor 2 and the stator 3 toward the outer circumference (toward the direction of the outer circumference) by centrifugal force to disperse it.

The dispersing device 1 comprises a container 11 for receiving the mixture that has been dispersed and a cover assembly 12 for closing the upper opening 11a of the container 11. For example, the cover assembly 12 is fixed to the container 11 by placing bolts 11d through the bolt holes 11c in the upper rim 11b of the container 11 and the bolt holes 18c in the cover assembly 12 (a part 18 for holding the stator, which is discussed below), to close the upper opening 11a.

The stator 3 is fixed under the cover assembly 12 (to the lower surface of the cover assembly 12). For example, the stator 3 is fixed there by placing bolts 3a through the bolt holes 3b in the stator 3 and the bolt holes 18b in the cover assembly 12 (the part 18 for holding the stator). The rotor 2 is disposed to face the lower surface of the stator 3.

The dispersing device 1 further comprises a rotary shaft 13 that rotates the rotor 2 and a bearing 14 that rotatably holds the rotary shaft 13. The bearing 14 is fixed to the cover assembly 12 and located above the stator 3.

The rotary shaft 13 is connected to a rotary shaft 16a of a motor 16 via a joint 16b. The motor 16 is disposed above the rotor 2 and the stator 3. The rotary shaft 13 is rotated by means of the motor 16 and transmits the force for rotation by the motor 16 to the rotor 2.

The dispersing device 1 comprises an assembly 171 for supplying the mixture that stores an unprocessed mixture that is to be supplied to the gap between the stator 3 and the rotor 2. The assembly 171 also supplies the unprocessed mixture to the gap between the stator 3 and the rotor 2. The assembly 171 has a body 172 that stores the mixture, a first member 173 for injecting the mixture, and a second member 174 for injecting the mixture.

The first member 173 for injecting the mixture pushes out the mixture that is stored in the body 172 to a supply route 175 for supplying the mixture to the gap between the stator 3 and the rotor 2, to thereby supply the mixture to the gap between the stator 3 and the rotor 2. For example, the combination of the first member 173 for injecting the mixture and the body 172 has a structure like a piston. Namely, they have a hollow cylinder and a cylinder that slides within it. However, their cross sections are not limited to being circular, but, for example, may be rectangular. Any sectional shape where the first member 173 slides within the body 172 so as to push out the mixture may be used. That is, any sectional shape may be used if the shape of the inner surface of the body 172 on a plane perpendicular to the longitudinal axis is the same as that of the plane for pressing of the first member 173.

The second member 174 for injecting the mixture is disposed to protrude from the plane 173a for pressing of the first member 173 for injecting the mixture. It is inserted into the supply route 175. It pushes out the mixture in the supply route 175 to thereby supply the mixture to the gap between the stator 3 and the rotor 2. For example, the combination of the second member 174 and the supply route 175 has a structure like a piston. Namely, they have a hollow cylinder and a cylinder that slides within it. However, their cross sections are not limited to being circular, but, for example, may be rectangular. Any sectional shape where the second member 174 slides within the supply route 175 so as to push out the mixture may be used. That is, any sectional shape may be used if the shape of the inner surface of the supply route 175 on the plane perpendicular to the longitudinal axis is the same as that of the plane for pressing of the second member 174.

The assembly 171 for supplying the mixture has a second port 176 for supplying the mixture that is attached to a port 33 for supplying the mixture of a part 18 for holding the stator, which is discussed below. It also has a second passage 177 that is used to supply the mixture in the body 172 to a passage 34 of the part 18 for holding the stator. The port 33 and the second port 176 are formed to have fastening members. For example, they are pipes with ferrules. They are connected by fastening the ferrules by means of a clamp. Incidentally, the fastening members are not limited to ferrules, but, for example, may be flanges.

The assembly 171 for supplying the mixture is integrated with the part 18 for holding the stator by attaching the second port 176 to the port 33 so that the second passage 177 communicates with the passage 34. The passage 34 and the second passage 177 constitute the supply route 175. The second port 176 for supplying the mixture or the second passage 177 need not be necessarily formed in the assembly 171. If neither is formed in the assembly 171, the passage 34 of the part 18 for holding the stator constitutes the supply route 175. Likewise, the port 33 for supplying the mixture or the passage 34 need not be necessarily formed in the part 18. If neither is formed in the part 18, the second passage 177 constitutes the supply route 175. Further, a through-hole 32 of the stator 3 may constitute the supply route 175 by adjusting the angle to form it. Incidentally, the supply route 175 is a pipe for supply at the parts where the port 33 and the second port 176 are formed, while it is a through hole for supply at the part where it penetrates the part 18. The above-mentioned supply route 175 is just an example. Any passage may be used that supplies the mixture that is stored in the body 172 to the gap between the stator 3 and the rotor 2 and into which passage the second member 174 for injecting the mixture can be inserted to push out the mixture.

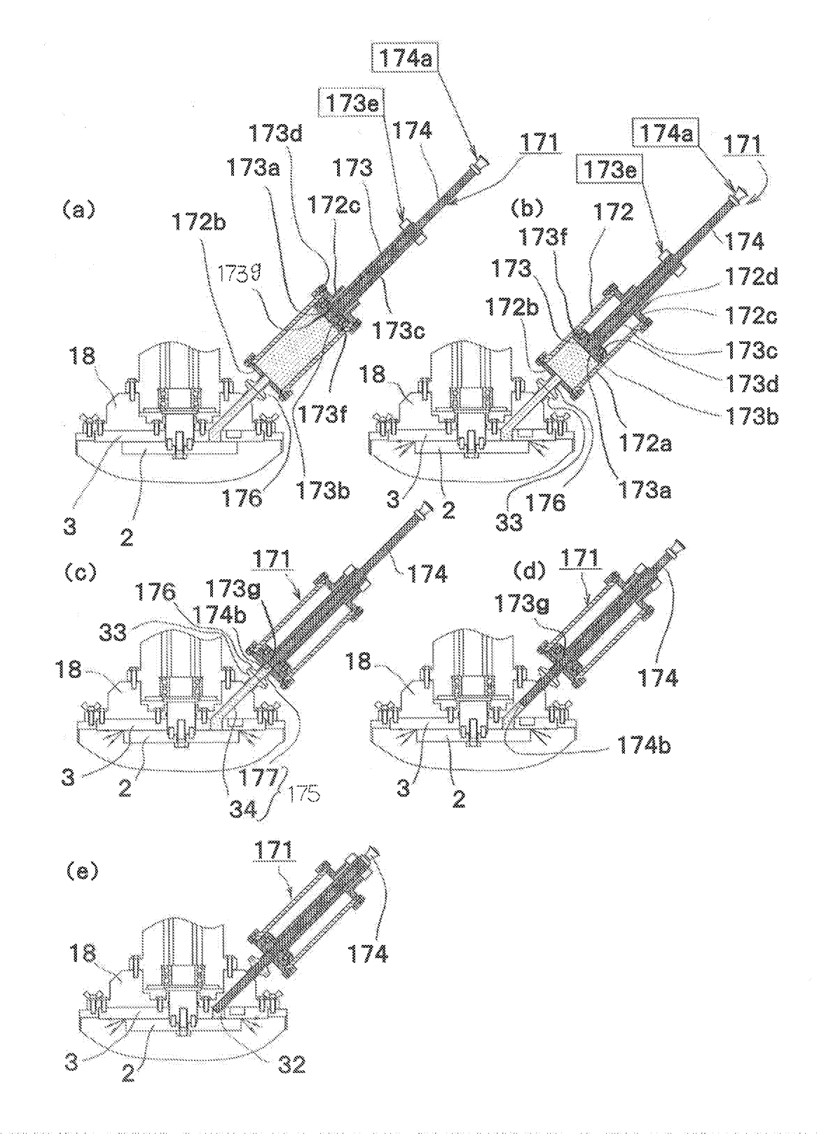

Specifically, as in FIG. 5, the body 172 has, for example, a cylindrical drum 172a, an obstruction 172b that obstructs one of the openings of the drum 172a, and an obstruction 172c that obstructs the other opening. The above-mentioned second port 176 is integrated with the obstruction 172b.

The first member 173 for injecting the mixture has a body 173b for pressing that has the plane 173a for pressing, and a guiding member 173c that guides the second member 174. The body 173b for pressing is fixed to the guiding member 173c by means of screws 173d. A driving part 173e is provided to the guiding member 173c that is used to drive the body 173b for pressing through the guiding member 173c in the direction for pressing and the direction for retrieving the body 172. In the above-mentioned obstruction 172c, a guiding part 172d is formed to guide and to slide the guiding member 173c. Incidentally, one or both of the driving part 173e and a driving part 174a, which is discussed below, may be omitted so that a user drives by his or her hands. A seal member 173f is provided to the outer sliding surface of the body 173b for pressing (the sliding surfaces of the first member 173 for injecting the mixture and the body 172). For the seal member 173f or a seal member 173g, which seal member 173g is discussed below, for example, an O-ring or a U-packing may be used. Further, a seal member that is made of a material suitable for the unprocessed mixture is preferable.

The second member 174 for injecting the mixture is formed in a shape such as a bar, so as to slide within the guiding member 173c. The driving part 174a is provided to the second member 174 so as to drive the second member 174 in the direction to protrude from the plane 173a for pressing and the direction to return toward it. As shown in FIGS. 5(c) and 5(d), when the second member 174 is driven in the direction to protrude from the plane 173a, the tip 174b of it pushes out the mixture in the supply route 175 to supply it to the gap between the stator 3 and the rotor 2. A seal member 173g is provided to the inner sliding surface of the body 173b for pressing (the sliding surfaces of the first member 173 for injecting the mixture and the second member 174). With the above-mentioned configuration, the second member 174 pushes out the mixture directly near a part of the rotor 2 and the stator 3 where shearing force is generated.

With the above-mentioned configuration the dispersing device 1 enables an appropriate dispersing process to be carried out with an improved yield. Namely, since it has the container 11, the cover assembly 12, the stator 3, and the rotor 2 as discussed above, the yield can be improved after the mixture is dispersed. Further, since the dispersing device 1 has the assembly 171 for supplying the mixture, the yield can be improved in the part for supplying the mixture. That is, when dispersing a viscous mixture, the yield may decrease because the mixture may adhere to the pipe for supply or a container for storing the unprocessed mixture. However, by the dispersing device 1, the first member 173 for injecting the mixture can supply the mixture in the body 172 toward the rotor 2 and the stator 3 (see FIGS. 5(a) to 5(c)). Further, the second member 174 for injecting the mixture can supply the mixture in the supply route 175 toward the rotor 2 and the stator 3 (see FIGS. 5(c) to 5(e)). By such a configuration, an amount of the unprocessed, mixture that remains upstream of the rotor 2 and the stator 3 is significantly reduced. Further, the dispersing device 1, which has the assembly 171 for supplying the mixture, can disperse a mixture that has a very low flowability or a slurry that is hardly pumped by a normal pump. Namely, it can disperse a mixture that has too low a flowability to be dispersed by a conventional dispersing device.

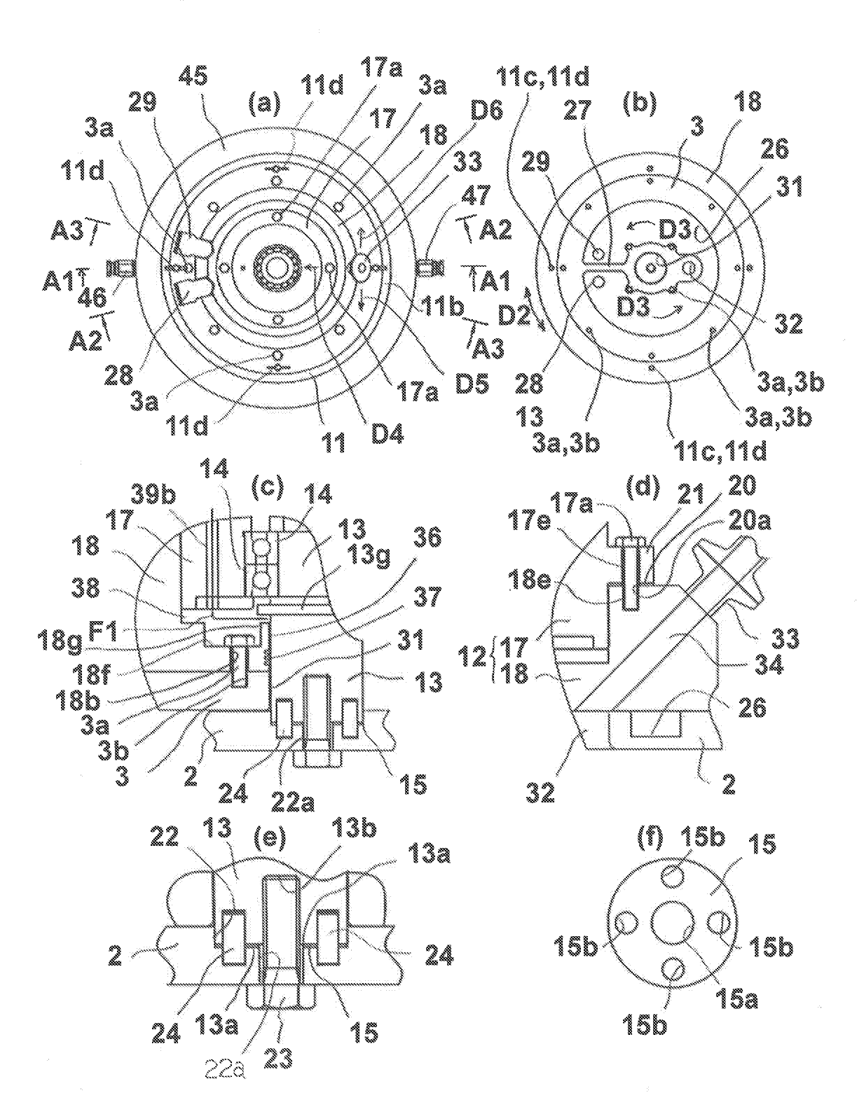

The dispersing device 1 comprises a spacer 15 that is detachably disposed between the rotary shaft 13 and the rotor 2 (see FIG. 3(c) and FIG. 3(e)). The spacer 15 causes the gap between the rotor 2 and the stator 3 to be adjusted by being replaced by another one that has a different length (thickness) in the direction of the dispersing device 1, i.e., the axial direction D1 of the rotary shaft 13. That is, spacers 15 that have various thicknesses are stocked so as to adjust the gap between the rotor 2 and the stator 3 by using one of them.

When the spacer 15 is disposed, the position of the rotor 2 in relation to the stator 3 in the axial direction is fixed. That is, a spring or a screw may be used to adjust the gap between the rotor 2 and the stator 3. However, when the spacer 15 is used, since the axial position of the rotor 2 is fixed during the operation, no countermeasures against vibrations by the spring or looseness by the screw need be considered. Further, if a spring or a screw is used, it is difficult to accurately move the rotor 2 without the rotor 2 being inclined. On the contrary; when the spacer 15 is used the rotor can be accurately moved without it being inclined.

By the dispersing device 1, the gap can accurately be adjusted by means of the above-mentioned structure. By the dispersing device 1, even if the rotary shaft 13 is thermally expanded due to unforeseen heat, the rotor 2 moves in the direction to be separated from the stator 3. Thus any contact between the rotor 2 and the stator 3 can be prevented. Further, producing excessive heat due to an unforeseen small gap, even though they do not contact each other, can be prevented. Further, since the bearing 14 is located above the stator 3, the rotary shaft 13 is located over the rotor 2. Since no part of the rotary shaft 13 is disposed under the rotor 2 (the rotary shaft 13 is upwardly disposed from the rotor 2), a reduction in the yield due to adhesion of the processed mixture on the rotary shaft 13, the bearing 14, etc., can be prevented. Namely, the yield can be improved.

The cover assembly 12 has a part 17 for holding the bearing 14 and the part 18 for holding the stator that is disposed under the part 17. The part 18 holds the stator 3. The part 17 for holding the bearing has a part 21 for controlling the axial position of the part 18 for holding the stator. The part 21 abuts the part 18 by means of a second spacer 20. For example, the part 17 is integrated with the part 18 by placing bolts 17a through the bolt holes 17e in the part 17 and the bolt holes 18e in the part 18 while the second spacer 20 is sandwiched between them (see FIG. 3(d)). Through-holes 20a are formed in the second spacer 20 so that the bolts 17a pass through them.

The second spacer 20 is detachably disposed between the part 17 for holding the bearing and the part 18 for holding the stator. It adjusts the position of the stator 3 in the axial direction D1 in relation to the part 17 by being replaced by another one that has a different length (thickness) in that direction D1. That is, the second spacers 20 that have various thicknesses are stocked so as to adjust the position of the stator 3 in the axial direction D1 by using one of them.

By replacing the spacer (also called “the first spacer”) 15 and the second spacer 20 with respective spacers, the gap between the rotor 2 and the stator 3 can be more precisely adjusted. That is, by replacing the spacer 15 with a thicker one, that gap becomes larger. By replacing the second spacer 20 with a thicker one, that gap becomes smaller. A combination of these replacements can achieve a more precise adjustment. For example, the spacers 15 and the second spacers 20 that have thicknesses from 0.01 mm to 0.50 mm in increments of 0.01. mm are stocked. They are replaced so that the gap between the rotor 2 and the stator 3 is adjusted to suit the viscosity and properties of the mixture.

The second spacer 20 causes the position of the stator 3 to be adjusted in relation to the part 17 for holding the bearing, i.e., the position of the lower surface of the stator 3, by the position of the part 18 for holding the stator in relation to the part 17 for holding the bearing being adjusted. Thus the position of the lower surface of the stator 3 can be kept constant regardless of the condition of the stator 3. For example, even when the stator 3 is replaced, the position of the lower surface of the stator 3 can be kept constant. Thus, for example, by keeping the position of the lower surface of the stator 3 at a predetermined position, the thickness of the spacer 15 can be the same as the gap between the rotor 2 and the stator 3, so that the structure is comprehensible to users. That is, to adjust the gap at a desired distance the spacer 15 that has the same thickness as the gap has to be chosen. This improves the convenience for the users who perform the dispersing process under the control of the gap.

A concave part 22 is formed on the upper surface of the rotor 2 so that the lower end 13a of the rotary shaft 13 is inserted into it (see FIGS. 3(c) and 3(e)). A through-hole 22a that opens on the concave part 22 is formed in the rotor 2. The lower end 13a of the rotary shaft 13 is inserted into the concave part 22 of the rotor 2. The lower end 13a abuts the concave part 22 by means of the spacer 15. A fastening member 23 is fixed to the rotary shaft 13 from the lower side of the rotor 2. The fastening member 23 is, for example, a bolt. In the lower end 13a of the rotary shaft 13 a female screw, as a fastening part 13b that is a counterpart of the fastening member 23, is formed.

The fastening member 23 fastens the rotary shaft 13 to the rotor 2 across the spacer 15 by fixing a part of it to the rotary shaft 13 through the hole 22a of the rotor 2. Pins 24 are inserted into the concave part 22 of the rotor 2 and the lower end 13a of the rotary shaft 13 to transmit the rotational power of the rotary shaft 13 to the rotor 2. Holes for receiving the pins 24 are formed in the concave part 22 of the rotor 2 and the lower end 13a of the rotary shaft 13.

The pins 24 are disposed at a uniform interval along the circumferential direction to transmit the rotational power of the rotary shaft 13 to the rotor 2. A first through-hole 15a through which the fastening member 23 passes and second through-holes 15b through which the pins 24 pass are formed in the spacer 15. In this embodiment four second through-holes 15b and four pins 24 are used.

Since the rotary shaft 13 and the rotor 2 are fastened across the spacer 15 by the fastening member 23, the axial position of the rotor 2 in relation to the stator 3 is definitely fixed. Thus the gap between the rotor 2 and the stator 3 can be made appropriate. That is, the spacer 15 with the above-mentioned advantages is properly used.

Since the pins 24 are used for transmitting the rotational power from the rotary shaft 13 to the rotor 2, the distribution of the power in the circumferential direction is improved in comparison with a structure in which a key and a keyseat are used. That is, the rotary shaft 13 and the rotor 2 rotate in a balanced way. Thus the dispersing power between the rotor 2 and the stator 3 is prevented from differing at different locations. That is, a uniform and appropriate dispersing process can be carried out. Since the difference in the dispersing power at different locations is prevented, the dispersing process can be stable when the gap is narrowed. Further, since the speed of the rotation can be increased, an appropriate dispersing process can be carried out.

The stator 3 is bigger than the rotor 2 on the plane where it faces the rotor 2. That is, the stator 3 on the plane perpendicular to the axial direction D1 is shaped to be larger than the rotor 2. In the stator 3 a groove 26 for cooling is formed on the surface (the upper surface) opposite the surface (the lower surface) that faces the rotor 2 so that a coolant flows through it. The groove 26 for cooling is located beyond the outer edge of the rotor 2.

Since the groove 26 for cooling is formed beyond the outer edge of the rotor 2, the outer edge of the rotor 2 can be cooled. That is, the entire areas for dispersion of the rotor 2 and the stator 3 can be cooled by the groove 26 for cooling. Thus generating heat in the material (the mixture being dispersed) can definitely be prevented. Thus the material that is to be dispersed is prevented from deteriorating. Further, even if the material is volatile and flammable, the dispersing process can be safely carried out. Conventionally, the rotor 2 and the stator 3 are shaped to have the same sizes on the plane they face. In such a case the outer edge cannot be cooled. Since the amount of heat generated is high at the outer edge, the groove 26 for cooling provides an excellent cooling effect. Thus the appropriate dispersing process can be carried out at an appropriate temperature range.

A wall 27 is formed along the radial direction on the groove 26 for cooling. A port 28 for supplying the coolant and a port 29 for discharging the coolant are disposed across the wall 27 on the groove 26. The coolant that is supplied from the port 28 to the groove 26 flows toward the direction D3, in which no wall 27 is formed near the port 28, in the circumferential direction D2. That coolant is discharged from the port 29. For example, the coolant can be water.

Since the groove 26 for cooling is configured to cause the coolant to flow from the port 28 for supplying the coolant to the port 29 for discharging the coolant in a single direction, namely, it ends so as to cause the coolant to flow in a single direction, the coolant is discharged in order of precedence. In other words, if it were not configured to cause the coolant to flow in a single direction, a part of the coolant would stay, so that the coolant might not be replaced by new coolant at a part of the groove for cooling, deteriorating the cooling ability. By contrast, since the groove 26 for cooling is configured to replace the coolant in order of precedence, the cooling ability is constantly high. Thus the appropriate dispersing process at the appropriate temperature can be carried out.

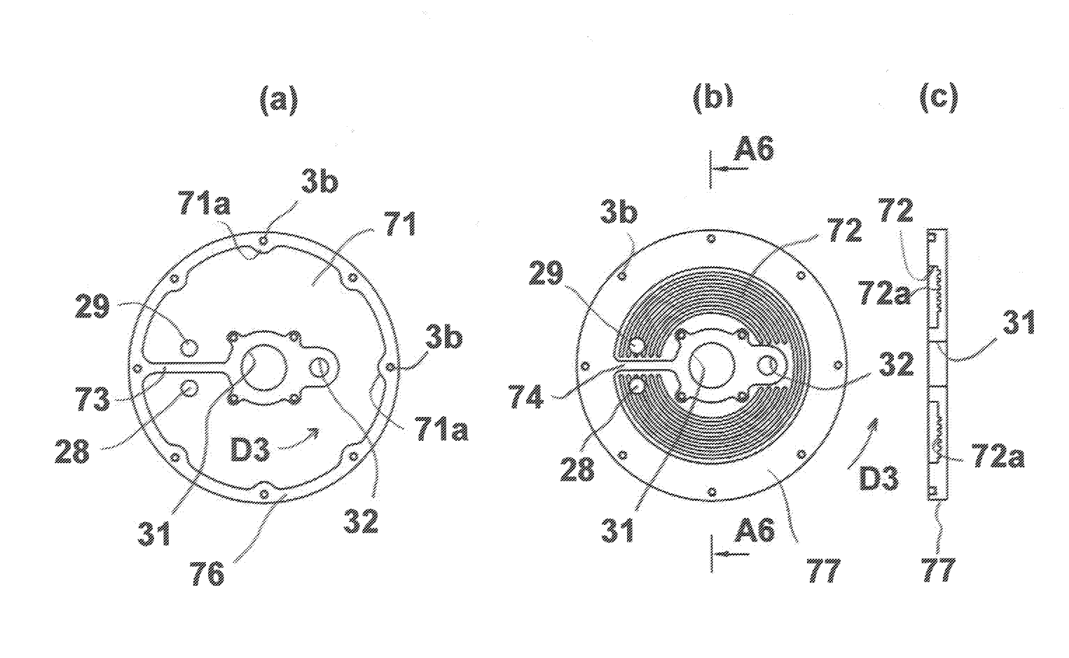

The groove for cooling and the stator, on which the groove is formed, are not limited to the above-mentioned structure. For example, as shown in FIG. 4, the stators 76, 77 with the grooves 71, 72 for cooling may be used. FIG. 4(a) illustrates an example by which the cooling ability is enhanced by widening the groove as much possible, except where the screws are located. FIG. 4(b) illustrates an example by which the cooling ability is enhanced by increasing the area to contact the coolant by forming fine grooves on the bottom of the groove. Since the stators 76, 77 have the same structure and function as the stator 3 except for the groove for cooling, a duplicate explanation is omitted.

As in FIG. 4, like the groove 26 for cooling, the grooves 71, 72 for cooling are formed in the upper surfaces of the stators 76, 77, respectively, which stators are larger than the rotor 2, so as to reach outside the rotor 2. Like the wall 27, the walls 73, 74 are provided to the grooves 71, 72 for cooling. A structure that is similar to that of the groove 26 for cooling has similar functions.

Next, a structure that differs from that of the groove 26 for cooling is discussed. The groove 71 for cooling is extended to the outer edge of the stator 76. In the portions in which the bolt holes 3b are formed, protrusions 71a are formed. Since the groove 71 extends toward the outer edge, the cooling effect is enhanced. The part where the maximum heat is generated is the outer edge of the rotor, since the speed of the rotation at that edge is fastest so that the maximum friction is generated by the shearing force there. Thus, since cooling that part is effective, the groove for cooling is extended to outside the outer edge of the rotor. On the bottom of the groove 72 for cooling concave parts 72a are formed in the circumferential direction. Thereby, the amount of heat exchange between the coolant and the stator 76 increases so as to increase the cooling effect. The grooves 71, 72 have a higher cooling effect, which is in addition to the effect caused by the groove 26. As discussed above, when the stator that has either of the grooves 71, 72 for cooling, instead of the groove 26 for cooling, is used, a high cooling function is obtained so that an appropriate dispersing process within an appropriate temperature range is carried out.

In the stator 3 a hole 31 for inserting the rotary shaft is formed through which the rotary shaft 13 passes. The mixture is supplied from outside the positions of the hole 31 of the stator 3 to the gap between the stator 3 and the rotor 2.

Specifically, a through-hole 32 for supplying the mixture is formed outside the hole 31 for inserting the rotary shaft in the stator 3. In other words, the through-hole 32 is located a certain distance from the hole 31. A port 33 for supplying the mixture, and a passage 34 that communicates with the through-hole 32 for supplying the mixture to the port 33 and is provided in the stator 3, are provided in the part 18 for holding the stator. The mixture that is supplied from the port 33 is introduced to the gap between the stator 3 and the rotor 2 through the passage 34 in the part 18 and the through-hole 32 in the stator 3. A flange for a connection is provided to an end of the port 33 for supplying the mixture so as to connect with a piping (the first piping 54), which is discussed below.

By this configuration, when the rotor 2 is rotated while the mixture is supplied, the mixture that has been supplied to the through-hole 32 is caused to flow outwardly by means of centrifugal force. Thus no mixture reaches near the center of the rotation. Thus no sealing member such as a mechanical seal is required in the hole 31 for inserting the rotary shaft (also called “a first hole for inserting the rotary shaft”) or a second hole 36 for inserting the rotary shaft, which second hole 36 is discussed below. Namely, the through-hole 32 is located at such a distance that no mixture flows to the hole 31. Thus the structure of the dispersing device can be simplified. Further, no replacement of the sealing member due to deterioration is needed.

The port 33 for supplying the mixture and the passage 34 are inclined in the direction D4, toward the radial center, as they become lower. However, they may be inclined, for example, in the tangential directions D5, D6 as they become lower. In this case the port 33 for supplying the mixture and the passage 34 are formed so that the bottom end of the passage 34 is located at a position to be connected to the through-hole 32. Thus the through-hole 32 can be located near the hole 31.

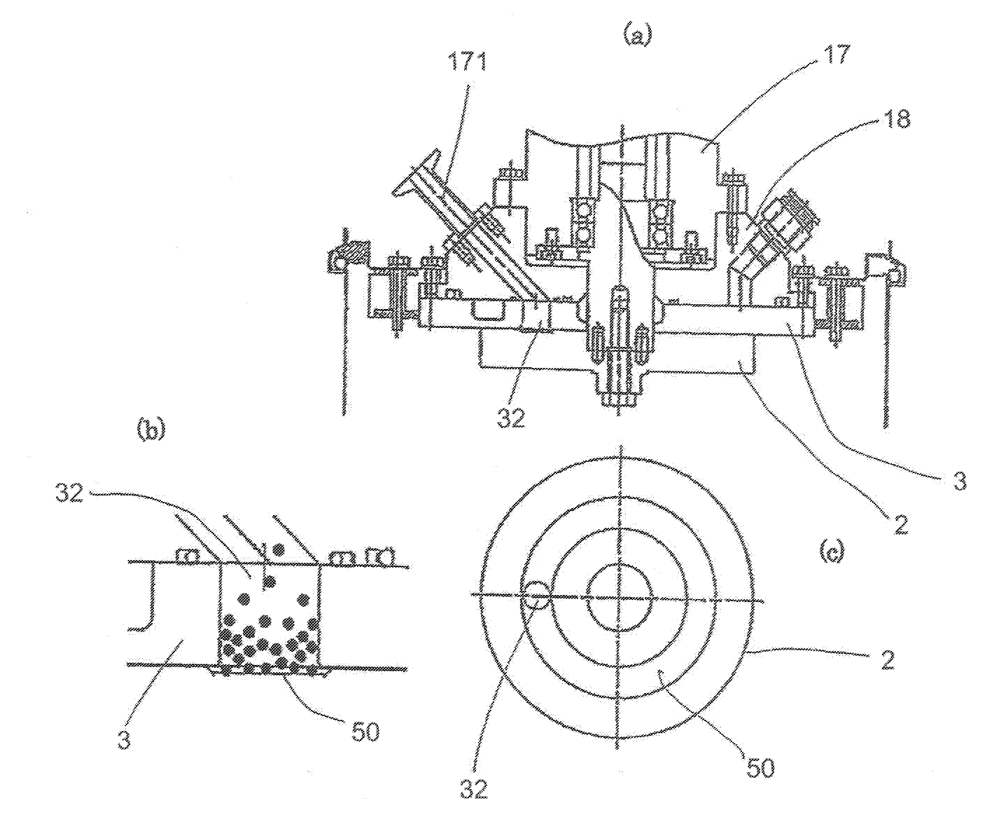

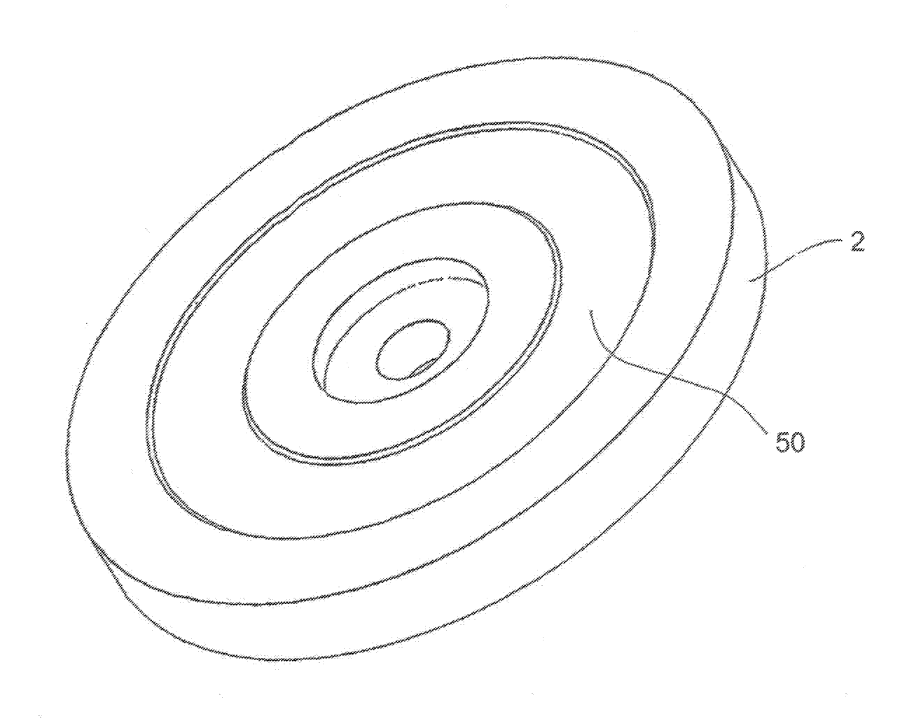

As in FIGS. 14 and 15, a circular groove 50 may be formed concentrically with the rotor 2 on its upper surface, which faces the stator 3. It is located at a position that corresponds to the through-hole 32 that is formed in the stator 3. When the mixture is supplied to the gap between the stator 3 and the rotor 2 through the through-hole 32, the flow path of the mixture is drastically narrowed. Namely, the flow path between the stator 3 and the rotor 2 is much narrower than the flow path in the through-hole 32. Thus when the mixture is highly viscous or has a high concentration of solids the entrance to the gap may clog. Especially, when the gap between the stator 3 and the rotor 2 is made narrow to increase the ability to make powdery substances finer, the entrance to the gap may often clog.

Since the circular groove 50 is formed concentrically with the rotor 2 on its upper surface, which faces the stator 3 and is located at a position that corresponds to the through-hole 32, which is formed in the stator 3, a problem where the entrance to the gap (a part in the through-hole 32) clogs can be solved, even when the mixture is highly viscous or has a high concentration of solids, namely, even when the mixture causes the entrance to clog if no groove is formed. Further, when no groove 50 is formed, even a mixture that does not cause the entrance to the gap (a part in the through-hole 32) to clog may impart too much force on the dispersion by means of the stator 3 and the rotor 2. If the groove 50 is formed, the mixture can be dispersed without that problem occurring.

The groove 50 is preferably formed as a circle, and concentrically with the rotor 2 on its upper surface, and is preferably located at the position that corresponds to the through-hole 32, which is formed in the stator 3. When the depth of the groove 50 is greater than the gap between the stator 3 and the rotor 2 on which no groove 50 is formed, the mixture is efficiently supplied to the gap. The depth of the groove 50 is preferably greater than the gap between the stator 3 and the part of the surface of the rotor 2 on which no groove 50 is formed, so that the mixture is supplied from the through-hole 32 to the gap by means of centrifugal force that is generated by the rotation of the rotor 2. Specifically, while the diameter of the through-hole 32, through which the mixture passes, is usually 2 to 30 mm, for example, the gap is preferably 10 to 500 μm and the depth of the groove 50 is preferably 0.5 to 2.0 nm. As in FIG. 14, the shape of the groove 50 is preferably a wide and inverted trapezoid in a cross section along the radial direction of the rotor 2. The width at the upper side of the groove 50 in that cross section is preferably greater than the length of the through-hole 32 in the radial direction of the rotor 2.

The shape, depth, or width at the upper side of the groove 50, which is formed on the upper surface of the rotor 2 and which is located at a position that corresponds to the through-hole 32, which through-hole 32 is formed in the stator 3, is not limited to the one that is discussed above, in so far as the mixture can be efficiently supplied from the through-hole to the gap between the stator 3 and the rotor 2.

The second hole 36 for inserting the rotary shaft, through which the rotary shaft 13 is inserted, is formed in the part 18 for holding the stator. A labyrinth seal 37, which is a noncontact seal, is provided to the second hole 36. Here the labyrinth seal has a configuration that has concavo-convex gaps in series between the rotary shaft and the fixed part by forming one or multiple concave parts and/or convex parts on one or both of the sides of the rotary shaft (the rotary shaft 13) and the fixed side (the part 18 for holding the stator). Such a configuration functions as a seal. The sizes of the concave parts and the convex parts are, for example, 0.01-3.00 mm.

Air is supplied from outside the part 18 for holding the stator to a space 38 that is located within the part 18 and is the upper part of the second hole 36 for inserting the rotary shaft. Thus a seal 39 by air purging is provided. The seal 39 by air purging has a space 38 that is formed by the part 17 for holding the bearing and the part 18 for holding the stator, a passage 39b for purging that is formed in the part 17 and that connects the space 38 to the outside, and a part 39a for supplying air that is provided at the outer side of the passage 39b to supply air for purging. The seal 39 by air purging supplies air that is supplied from the part 39a to the gap between the second hole 36 and the rotary shaft 31 through the passage 39b and the space 38 as shown by the arrow F1. This air provides the sealing function.

On the outside of the second hole 36 in the part 18 for holding the stator a concave part 18f is formed to receive a bolt 3a for fixing the stator 3 to the part 18. Since the concave part 18f is formed, an inner circumference 18g that forms the second hole 36 for inserting the rotary shaft is shaped like a projection. The rotary shaft 13 has a projection 13g that projects over the inner circumference 18g of the part 18. As shown by the arrow F1, the air that has been supplied passes through the gap between the inner circumference 18g and the projection 13g and is supplied to the gap between the second hole 36 for inserting the rotary shaft and the rotary shaft 31.

The labyrinth seal 37 enhances the sealing effect on the second hole 36 for inserting the rotary shaft by means of a labyrinth. The seal 39 by air purging enhances the sealing effect on the hole 31 for inserting the rotary shaft and the second hole 36 for inserting the rotary shaft by means of purging. In the device 1 as discussed above, since the mixture is introduced to such a position that centrifugal force is effectively utilized, neither a labyrinth seal nor a purging mechanism must be provided. However, one of these may be provided to enhance the sealing effect. Both may be provided to further enhance the sealing effect.

A cooling mechanism 41 that has a cooling function is provided to the container 11. The container 11 has a conical wall 42 that has a smaller cross section from the top to the bottom, a cylindrical wall 43 that is located on the conical wall 42, and a port 44 for discharging at the lower end of the conical wall 42. The port 44 for discharging is provided at the lower end of the container 11 to discharge the mixture that has been dispersed. At the end of the port 44 a flange for a connection is provided so that a piping is connected to it. Since the mixture after being dispersed is discharged through the conical wall 42, the amount of the mixture that adheres to the inner wall and that is not discharged drastically decreases. Thus the yield is improved and an appropriate process is carried out. A vacuum pump may be provided to the container 11 so that air is prevented from being mixed in the mixture.

For example, the cooling mechanism 41 includes the wall 42 and the wall 43 that together form the outer surface of the container 11. It also has a member 45 for forming the space that covers the outer surface (the wall 42 and the wall 43), which member is located outside the walls. It also has a port 46 for supplying a cooling medium and a port 47 for discharging a cooling medium. For example, the member 45 for forming the space may be a member that is generally called a jacket and forms a space 48 between it and the walls 42 and 43 so that a cooling medium, such as cooling water, is filled in it.

For example, the port 46 for supplying a cooling medium is provided on the lower side of the member 45 for forming the space so as to supply the cooling water to the space 48. For example, the port 47 for discharging the cooling medium is provided on the upper side of the member 45 for forming the space so as to discharge the cooling water from the space 48.

By the above configuration the mechanism 41 has a function to cool the inside of the container 11 through the walls 42, 43. The cooling mechanism 41 also cools the mixture that has been dispersed. If a volatile material is to be dispersed, the vaporized material is cooled to return to a liquid form.

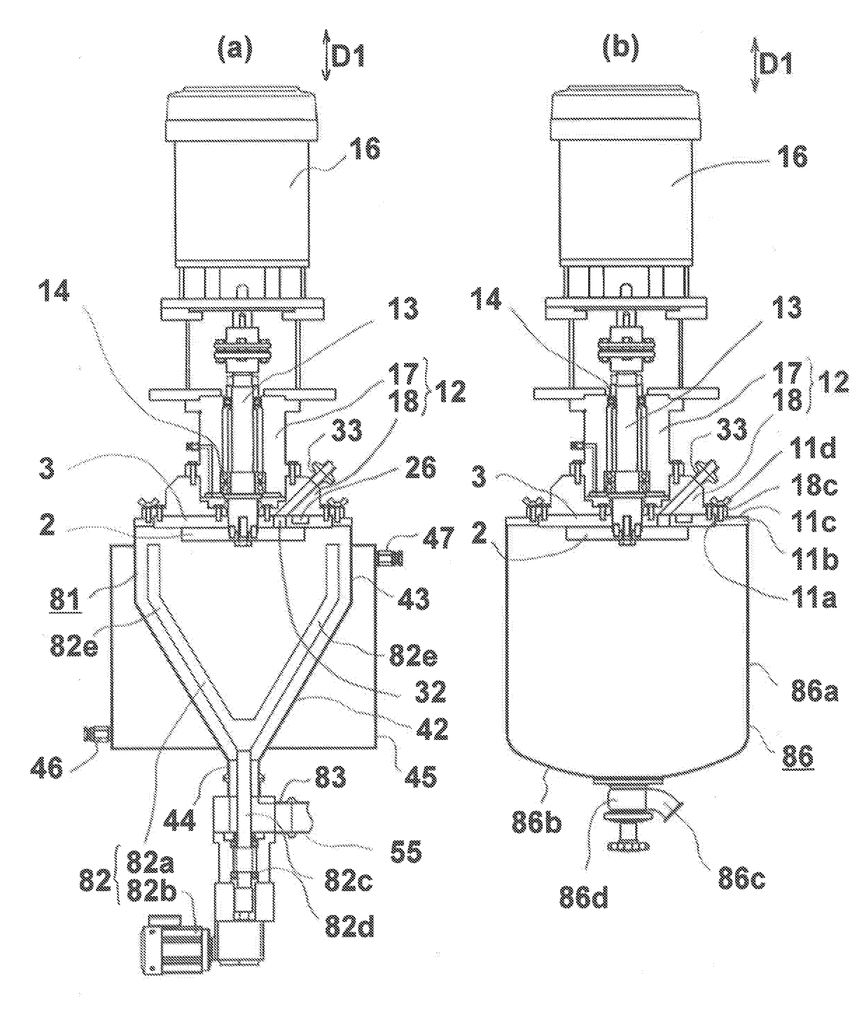

The container that constitutes the dispersing device 1 is not limited to the container 11, but may be the containers 81, 86 as in FIG. 6. First, the container 81 as in FIG. 6(a) is discussed. The container 81 has the same structure and functions as those of the container 11 except for having an agitator 82. So a duplicate explanation is omitted.

The container 81 as in FIG. 6(a) has the walls 42, 43 and the port 44 for discharging. The container 81 is equipped with the cooling mechanism 41. The container 81 is also equipped with the agitator 82. The agitator 82 scrapes the slurry mixture that adheres to the inner surfaces of the walls 42, 43 to discharge it. The agitator 82 has an agitating plate 82a that is shaped so as to follow the shape of the walls 42, 43 and a motor 82b that rotates the plate 82a. The agitator 82 also has a rotary shaft 82c and a bearing 82d. The agitating plate 82a is shaped so that the clearance between it and the walls 42, 43 is about 0-20 mm. The agitating plate 82a is made of metal or metal and resin. Here the agitating plate 82a has two agitating parts 82e so as to scrape at two positions on the circumference. However, it may have three or more agitating parts by combining plates, or just one agitating part. In the example shown in FIG. 6(a), from the need to dispose the rotary shaft 82c the port 44 for discharging is connected to a connecting pipe 83 so as to be connected to a piping through it. Since the mixture after being dispersed is discharged through the conical wall, the amount of the mixture that adheres to the inner wall and that is not discharged drastically decreases. Further, the agitating plate facilitates the discharge of the mixture. Thus the yield is improved.

Next, as another example of the container that constitutes the dispersing device 1, the container 86 as in FIG. 6(b) is discussed. The container 86 doubles as a tank for storing the mixture after being dispersed. Namely, the container 86 has a cylindrical wall 86a and a spherical bottom 86b that is located under the cylindrical wall 86a. A port 86c for discharging is provided at the lower end of the bottom 86b with an on-off valve 86d.

The container 86 as in FIG. 6(b) is compatible with the mixture that is completely dispersed in a single dispersion, as discussed below. For example, it is compatible with a process for dispersing a small amount of the mixture, that needs to be appropriately dispersed, and that is expensive. After the process for dispersing, the bolts 11d are removed to dismount the container 86 from the cover assembly 12, or the rotor 2 and the stator 3 that are attached to the cover assembly 12. The container 86 can be directly used as a container for transporting and be transported to a desired location. Thus the mixture that would adhere to the outer surface of the dispersing device in another structure can be recovered, so that the yield is improved. The shape of the container 86, which doubles as the tank for storing the mixture after the process, is not limited to it, but may be conical. Alternatively, it may be a large tank for accepting a large amount of the mixture being dispersed, or for being, for example, divided into two parts. The container that doubles as the tank for storing the mixture after the process may be equipped with the cooling mechanism 41.

For example, a stainless steel, such as SUS304, SUS316, SUS 316L, or SUS 430, or a carbon steel, such as S45C or S55C, may be used for the raw material of the rotor 2 and the stator 3, which constitute the dispersing device 1. A ceramic, such as alumina, silicon nitride, zirconia, sialon, silicon carbide, or a tool steel, such as SKD or SKF, may be used. A metal such as a stainless steel on which a ceramic is thermal sprayed (for example, alumina thermal spraying or zirconia thermal spraying) may be used. By using the rotor and the stator that are made of a metal on which a ceramic is thermal sprayed, the life can be prolonged and any contamination by metal can be prevented.

By the process for dispersing in which the dispersing device 1 is used the mixture is supplied between the rotor 2 and the stator 3 of the dispersing device 1 to cause the mixture to flow toward the outer circumference by centrifugal force so that the mixture is dispersed. By the dispersing device 1 and the process for dispersing, the yield can be improved (the yield is improved both in the part for supply and the part after dispersion) and an appropriate dispersion can be carried out. Further, the dispersing power is high and the dispersing process is carried out within an appropriate temperature range. That is, an appropriate dispersing process is carried out. By the dispersing device 1 and the process for dispersing, since the container 11 and the cover assembly 12 can be separated for cleaning after the dispersing process, the cleaning is easy.

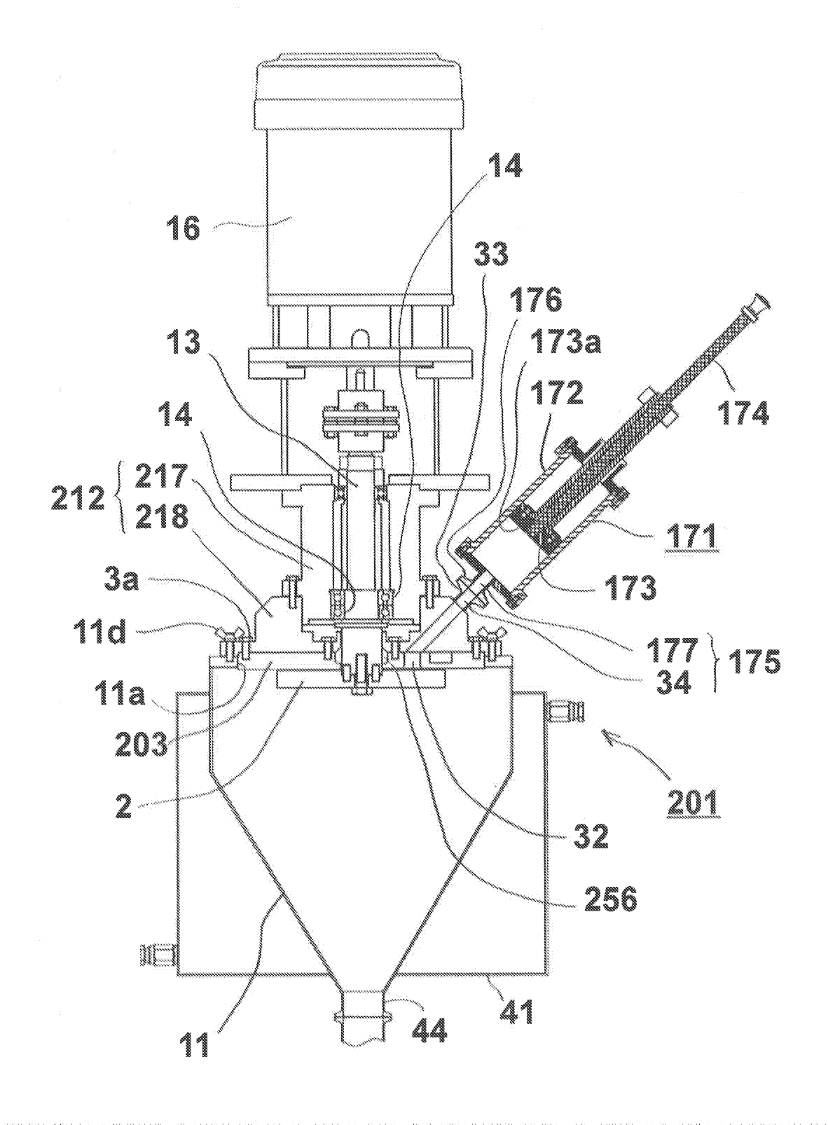

By the dispersing device 1 or the process for dispersing as discussed above, an appropriate dispersion can be carried out with the above-mentioned merits. However, the shear-type dispersing device of the present invention is not limited to it. For example, a shear-type dispersing device (below, “the dispersing device”) 201 as in FIGS. 7 to 10 may be used.

Next, the dispersing device 201 as in FIGS. 7 to 10 is discussed. The dispersing device 201 has the same structure as the dispersing device 1, except for having a first, a second, and a third vent-hole 251, 252, 253, respectively, and parts 254, 255 for forming a space. Thus the same or similar elements have the same reference numerals, and so a duplicate explanation is omitted. The dispersing device 201 has the same structure as the structure of the dispersing device 1 that is shown in FIGS. 3(b), (d), (e), and (f), though it is omitted in the drawings. The concave part 18f and bolts 3a of the dispersing device 1 that is discussed with reference to FIG. 3(c) are provided to the dispersing device 201, though they are neither shown in the drawings nor discussed.

The dispersing device 201 has a stator 203 and a cover assembly 212, which are discussed below, in addition to the above-mentioned rotor 2, container 11, rotary shaft 13, and bearing 14. It also has the assembly 171 for supplying the mixture that is discussed above. It also has the spacer 15 and the second spacer 20. Further, it also has the groove 26 for cooling. However, it may have the grooves 71, 72 for cooling as in FIG. 4, instead of the groove 26.

The stator 203 has the same structure and functions as those of the stator 3, except that a part 254 for forming a space, which is discussed below, is provided. The cover assembly 212 has a part 217 for holding the bearing 14 and a part 218 for holding the stator 203, which part 218 is disposed below the part 217. The part 217 for holding the bearing has the same structure and functions as those of the part 17 for holding the bearing, except that a third vent-hole 253, which is discussed below, is provided. The part 218 for holding the stator has the same structure and functions as those of the part 18 for holding the stator, except that a first vent-hole 251, a second vent-hole 252, and a part 255 for forming a space, which are all discussed below, are provided, and that no seal 37, i.e., the labyrinth seal, is provided to the part 18. The dispersing device 201, which is discussed here, has the advantageous effects as discussed below, since it has the first, second, and third vent-holes 251, 252, 253, which are discussed below, instead of the seal 37, the labyrinth seal, and the seal 39 by air purging.

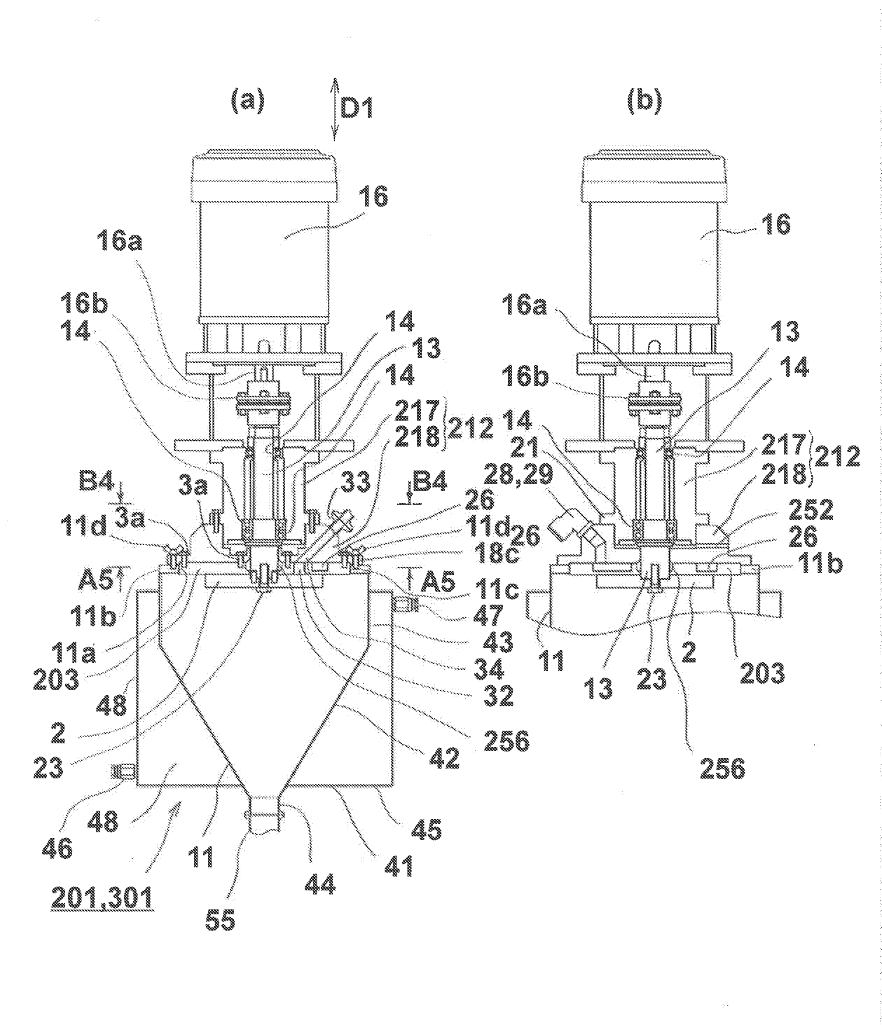

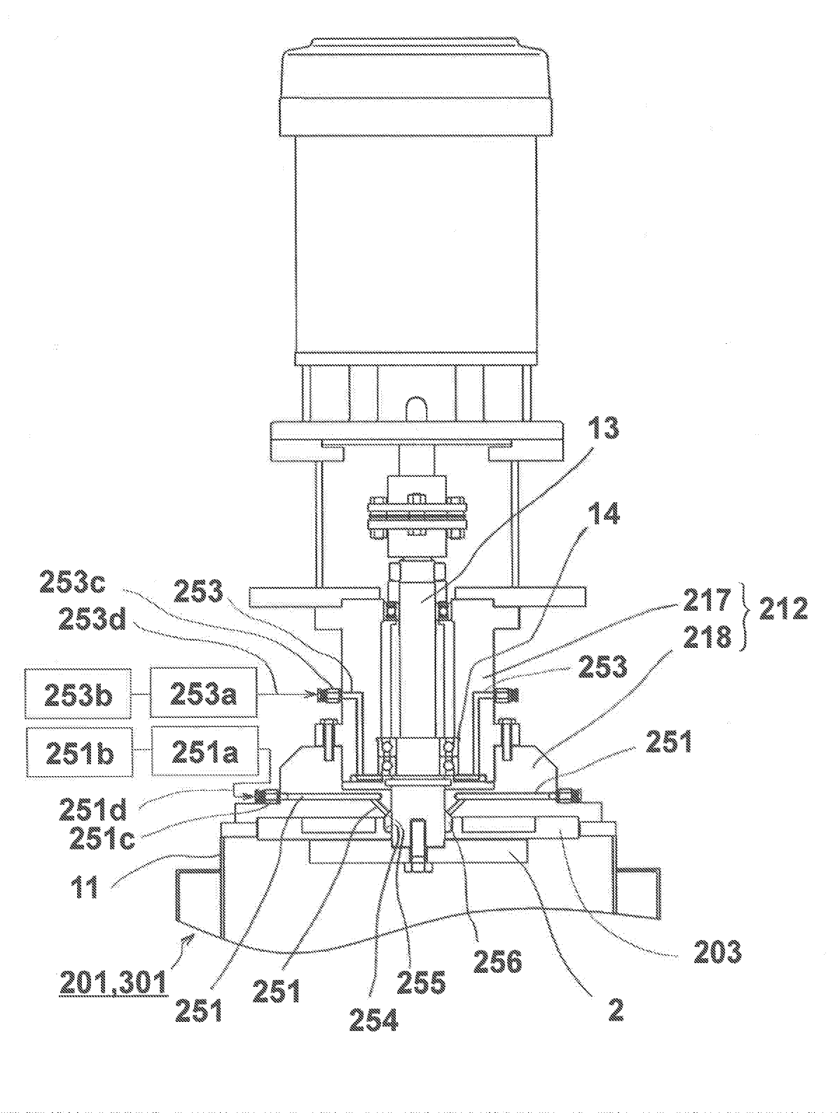

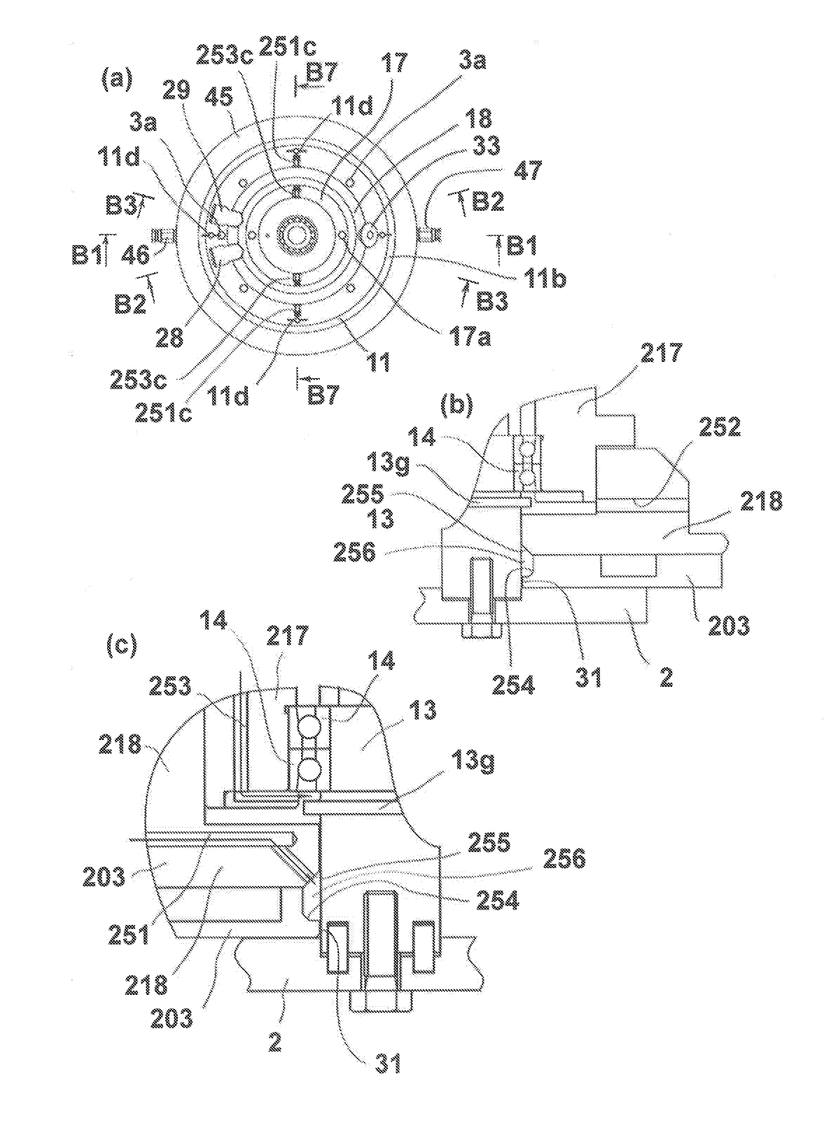

The first vent-hole 251 is formed in the part 218 for holding the stator to supply gas (for example, air) to the hole 31 for inserting the rotary shaft of the stator 203 (see FIGS. 9 and 10(c)). In the part 218 a second hole 36 for inserting the rotary shaft 13 is formed like the above-mentioned part 18. In the dispersing device 201, the second vent-hole 252 is formed in a space that is located under the part 217 for holding the bearing and over the second hole 36 for inserting the rotary shaft. The second vent-hole 252 provides a path of air that reaches the outside of the part 218. For example, the second vent-hole 252 is formed in the part 218 (see FIGS. 8(b) and 10(b)). Incidentally, though the second vent-hole 252 is formed in both a cross section B2-B2 and a cross section B3-B3, as in FIG. 10(a), it may be formed in only one section. Alternatively, it may be circumferentially formed in three or more sections. Likewise, the first vent-hole 251 and the third vent-hole 253 may be formed in one section or three or more sections. The pressure of the gas that is supplied through the first vent-hole 251 is higher than the pressure in the space that is ventilated through the second vent-hole 252. For example, the first vent-hole 251 has a part 251a for supplying gas that is connected through a connecting port 251c and a pipe 251d for supplying gas. It also has a part 251b for regulating the pressure of the supplied gas. The third vent-hole 253 has a part 253a for supplying gas that is connected through a connecting port 253c and a pipe 253d for supplying gas. It also has a part 253b for regulating the pressure of the supplied gas. Incidentally, the second vent-hole 252 is configured to ventilate with the ambient air. However, it may be configured to have a part for supplying gas and a part for regulating the pressure, like the first and third vent-holes 251, 253.

Now, the functions of the first vent-hole 251 are discussed. As discussed above regarding using the rotor 2 and the stator 3, the rotor 2 and the stator 203 have a structure by which the mixture hardly reaches the center of the rotation because of the configuration of the through-hole 32 for supplying the mixture. Thus no seal, such as a mechanical seal, needs to be provided. However, attention is needed so that the amount of the unprocessed mixture (for example, the amount that is supplied by the assembly 171 for supplying the mixture) does not exceed an amount that can be processed by means of centrifugal force. The dispersing device 201 is pressurized by the first vent-hole 251. Thus it is more difficult for the mixture to reach the center of the rotation so as to protect the bearing. In other words, the amount of the mixture to be supplied can increase.

By using the dispersing device 201 that has the second vent-hole 252, if the unprocessed mixture is supplied at an amount that exceeds the amount allowed by the centrifugal force and the pressure by the first vent-hole 251, any excessive mixture can be discharged through the second vent-hole 252. Thus the bearing can be protected. Further, if no second vent-hole 252 were formed, it would not be known if the mixture reaches the bearing until the bearing is damaged. However, since the mixture is discharged through the second vent-hole 252, the fact that the mixture reaches the part where the second vent-hole 252 is formed, i.e., just before the bearing, can be detected.

A part for forming a space is formed in a part for inserting the rotary shaft 13 (the hole 31 for inserting the rotary shaft and the second hole 36 for inserting the rotary shaft) of either or both of the stator 203 and the part 218 for holding the stator. In this embodiment, a part 254 for forming a space is formed in the stator 203 and a part 255 for forming a space is formed in the part 218 for holding the stator. A space 256 that is formed by means of the parts 254, 255 functions as a buffer.

The first vent-hole 251 is configured to communicate with the space 256 that is formed by means of the parts 254, 255. It supplies gas at a predetermined pressure to the hole 31 for inserting the rotary shaft of the stator 203 through the space 256 (the buffer).

By the dispersing device 201 that has the space 256 as a buffer, the mixture is to a greater extent prevented from reaching the upper part, in comparison with a dispersing device that has no buffer. Further, if the unprocessed mixture is supplied at an amount that exceeds the amount allowed by the centrifugal force, by the effects by the buffer (force for passing through the buffer), and by the pressure by the first vent-hole 251, extra time is available to start discharging the mixture through the second vent-hole 252.

The third vent-hole 253 is formed in the part 217 for holding the bearing so as to supply gas (for example, air) to a space next to the bearing 14 on the side near the stator (specifically, a space above the projection 13g). By the dispersing device 201, since it has the third vent-hole 253, the mixture is discharged through the second vent-hole 25 so as not to reach the bearing. Incidentally, the space to which the gas is supplied through the third vent-hole 253 and the space that is ventilated through the second vent-hole 252 are separated by a small gap between the projection 13g and the part 18 for holding the stator. The space that is ventilated through the second vent-hole 252 and the space (a buffer) 256 to which gas is supplied through the first vent-hole 251 are separated by the second hole 36 for inserting the rotary shaft, which forms a small gap. These small gaps are formed to be such a size that a condition for adjusting the pressure, which is discussed below, can be maintained. The condition for adjusting the pressure by means of the first, second, and third vent-holes 251, 252, 253, is selected from a first condition for adjusting the pressure and a second condition for adjusting the pressure. Incidentally, the device may be structured to carry out the first or second condition for adjusting the pressure. Or, the device may be structured to have a part for regulating the pressure of the gas (for example, air) that is supplied through the first, second, and third vent-holes 251, 252, 253 so as to switch the first and second conditions for adjusting the pressure by changing the pressure.

In the first condition for adjusting the pressure, the pressure of the gas that is supplied through the third vent-hole 253 is set higher than, or equal to, the pressure of the gas that is supplied through the first vent-hole 251. That is, the first condition complies with P2<P1≦P3, where P1 is the pressure of the gas supplied through the first vent-hole 251 (the first pressure), P2 is the pressure of the gas supplied through the second vent-hole 252 (the second pressure), and P3 is the pressure of the gas supplied through the third vent-hole 253 (the third pressure). This first condition is the best for protecting the bearing 14. Since P1 is set higher than P2, a capability for preventing the mixture from reaching the center of the rotation is created, in addition to the centrifugal force. Further, since P3 is set to the highest pressure, to the maximum extent possible the mixture is prevented from reaching the bearing 14.

In the second condition for adjusting the pressure, the pressure of the gas that is supplied through the third vent-hole 253 is set higher than the pressure of the gas that is supplied through the second vent-hole 252, but lower than, or equal to, the pressure of the gas that is supplied through the first vent-hole 251. That is, the second condition complies with P2<P3≦P1, where P1, P2, and P3 are the same as mentioned above. This second condition is the best for increasing the amount of the unprocessed mixture (raw material). Since P3 is set higher than P2, a capability for preventing the mixture from reaching the center of the rotation is created, even if the mixture reaches the position where the second vent-hole 252 is formed. Further, since P1 is set higher than, or equal to, P3, the maximum capability for preventing the mixture from reaching the center of the rotation is created, in addition to the centrifugal force. Thus the amount of the mixture to reach the second vent-hole 252 (this amount is the maximum) can be increased. Further, by finding out that the mixture is being discharged through the second vent-hole 252 the maximum amount is determined that is necessary to carry out a desired operation.

By the method for dispersing that uses the above-mentioned dispersing device 201, the mixture is supplied to the gap between the rotor 2 and the stator 203 to cause it to flow toward the outer circumference by means of centrifugal force, to thereby disperse it. The dispersing device 201 and the method for dispersing can improve the yield (the yield is improved both in the part after dispersing and in the part for supplying the mixture) and can achieve an appropriate dispersing process. Further, it can achieve a dispersing process that has a high ability to disperse and that is carried out within an appropriate temperature range. Namely, an appropriate dispersing process can be carried out. Further, cleaning can be facilitated by it, since the container 11 and the cover assembly 212 are separated for cleaning after the dispersing process is over. Further, they can achieve an appropriate dispersing process where the bearing is protected with an appropriate amount of the unprocessed mixture to be supplied and with an appropriate dispersing rate.

The above-mentioned dispersing device 201 and method for dispersing can achieve an appropriate dispersing process that has the above-mentioned merits. However, the shear-type dispersing device of the present invention is not limited to it. For example, a dispersing device 301 (see FIGS. 8 and 9) may be structured so as to be used as the dispersing device 201, but the assembly 171 for supplying the mixture is then removed. The dispersing device 301 has the same structure and functions as the dispersing device 201, except for having no assembly 171 for supplying the mixture. Namely, like the dispersing device 201, it has the rotor 2, the container 11, the rotary shaft 13, the bearing 14, the stator 203, the cover assembly 212, the first, second, and third vent-holes 251, 252, 253, and parts 254, 255 for forming a space.

By the method for dispersing that uses the above-mentioned dispersing device 301, the mixture is supplied to the gap between the rotor 2 and the stator 203, to cause it to flow toward the outer circumference by means of centrifugal force, to thereby be dispersed. The dispersing device 301 and the method for dispersing can improve the yield (the yield is improved in the part after dispersing) and can achieve an appropriate dispersing process. Further, it can achieve a dispersing process that has a high ability to disperse and that is carried out within an appropriate temperature range. Namely, an appropriate dispersing process can be carried out. Further, cleaning can be facilitated by it, since the container 11 and the cover assembly 212 are separated for cleaning after the dispersing process is over. Further, it can achieve an appropriate dispersing process where the bearing is protected with an appropriate amount of the unprocessed mixture to be supplied and with an appropriate dispersing rate.

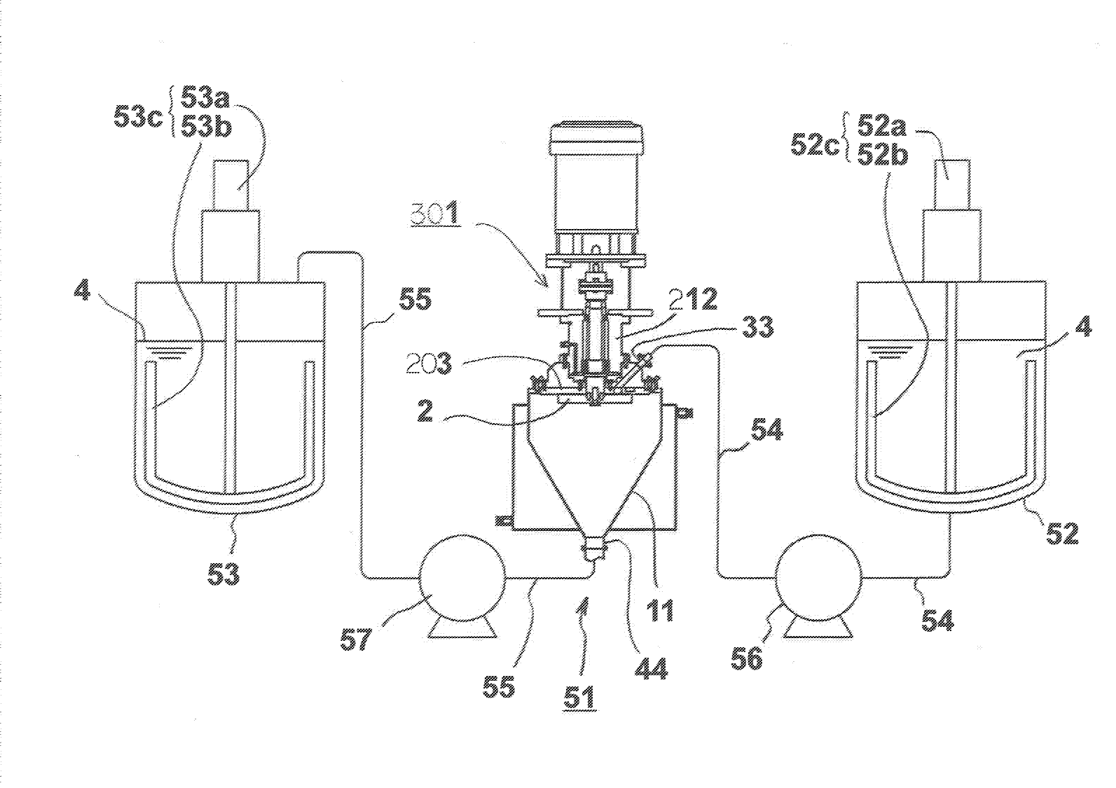

Next, the dispersing system 51 that uses the dispersing device 301 is discussed. The dispersing system 51 as in FIG. 11 comprises the dispersing device 301, a tank 52 for storing a mixture before the process, a tank 53 for storing a mixture after the process, a first piping 54, and a second piping 55. The tank 52 for storing a mixture before the process stores the mixture that is supplied to the dispersing device 301. The tank 53 for storing a mixture after the process stores the mixture that has been dispersed by the dispersing device 301. The first piping 54 connects the dispersing device 301 with the tank 52 for storing a mixture before the process. The second piping 55 connects the dispersing device 301 with the tank 53 for storing a mixture after the process.

A pump 56 is provided on the first piping 54. The pump 56 supplies the mixture in the tank 52 for storing a mixture before the process to the dispersing device 301, i.e., the port 33 for supplying the mixture of the dispersing device 301. A pump 57 is provided on the second piping 55. The second pump 57 supplies the mixture in the container 11 of the dispersing device 301 to the tank 53 for storing a mixture after the process.

An agitator 52c that has a motor 52a and an agitating plate 52b is provided to the tank 52 for storing a mixture before the process. The agitator 52c agitates the mixture before the process to preliminarily disperse it. For example, a part for supplying the liquid and a part for supplying the powder can be provided to the tank 52 for storing a mixture before the process so that the liquid and the powder are supplied to the tank 52 to be agitated. That is, a preliminary dispersion can be carried out. The dispersing system 51 performs the preliminary dispersion by the agitator 52c and the dispersing process in a single dispersion by the dispersing device 301. Thus the efficiency in dispersing is high. An agitator 53c that consists of a motor 53a and an agitating plate 53b is provided to the tank 53 for storing a mixture after the process. The agitator 53c homogenizes the mixture after being dispersed. A vacuum pump may be provided to the tank 53 and an on-off valve may be provided to the second piping 55. By using the vacuum pump, the on-off valve, and the agitator 53c the mixture after being dispersed can be defoamed. If a contact seal, such as a lip seal, is provided to the dispersing device 301 instead of the on-off valve, the mixture is defoamed while it is being dispersed.

The dispersing system 51 disperses the mixture by processing the mixture that has been stored in the tank 52 for storing a mixture before the process by the dispersing device 301 and by supplying the dispersed mixture to the tank 53 for storing a mixture after the process. The dispersing system 51 is suitable for a dispersing process in which the mixture passes between the rotor 2 and the stator 203 of the dispersing device 301 one time, namely, “in a single dispersion.” By the dispersing process in a single dispersion no shortcut is generated so that no inhomogeneous dispersion occurs. Thus the system can be simplified and the cost for constructing the devices can be saved. Further, since the dispersing device 301 is included, the yield is good, the dispersing power is strong, and the dispersing process can be carried out within an appropriate temperature range. Namely, the appropriate dispersing process can be carried out.

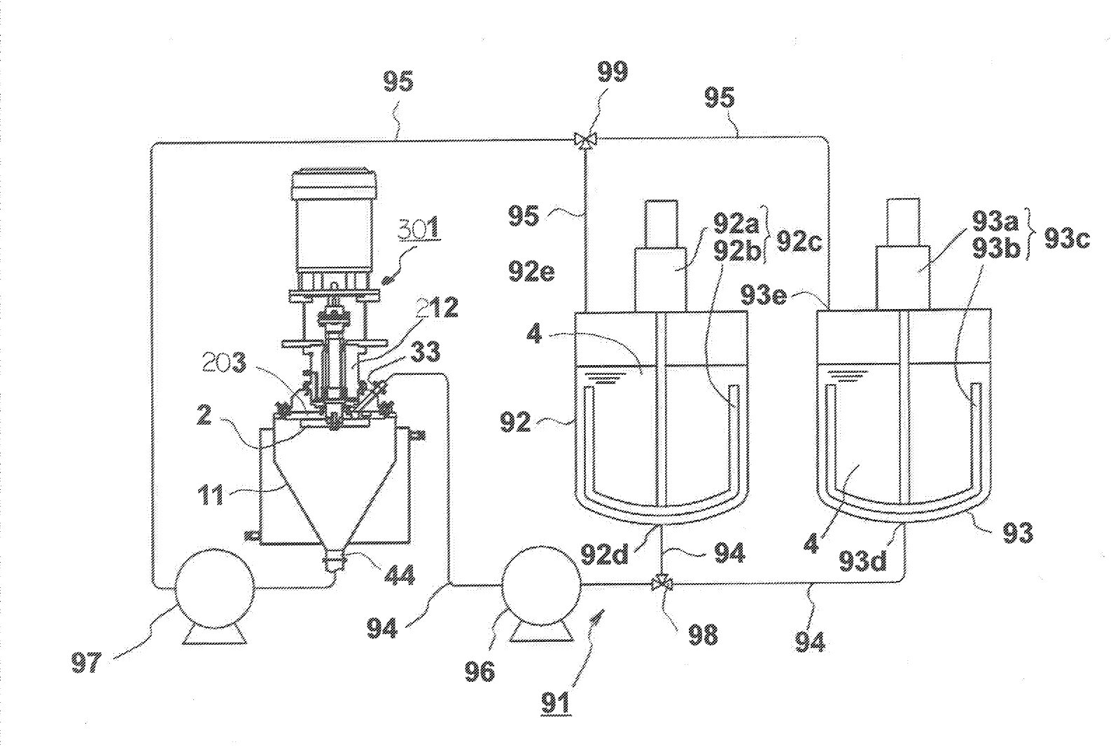

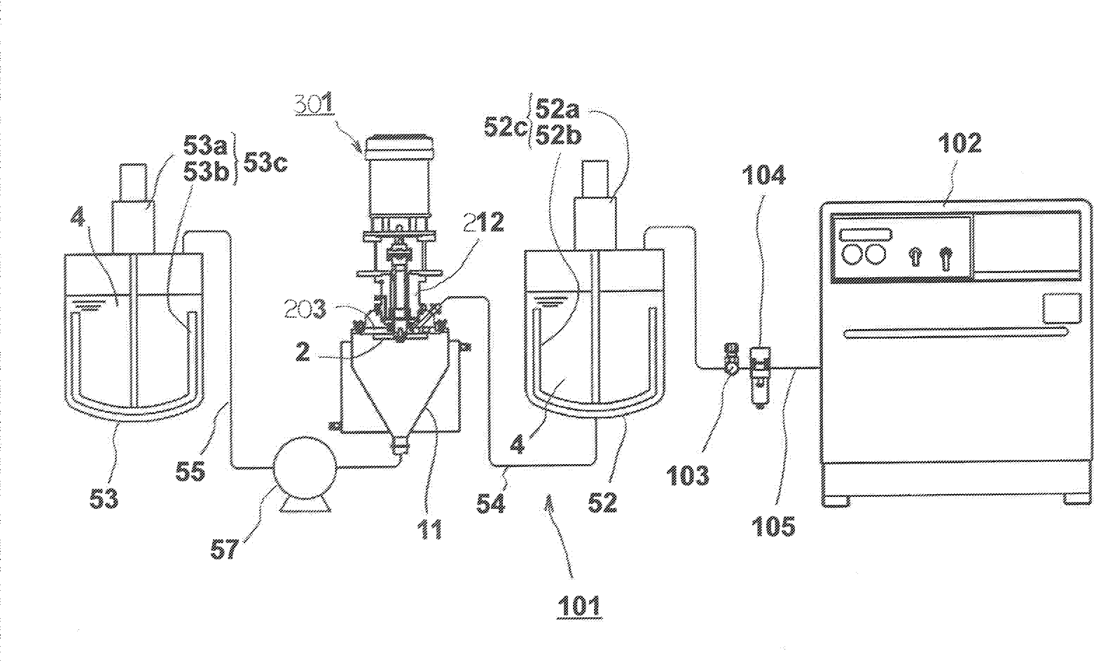

The dispersing system that uses the dispersing device 301 is not limited to the dispersing system 51 as in FIG. 11, but may be, for example, the dispersing system 91 or the dispersing system 101 as in FIG. 12 or 13. The dispersing system 91 has the same structure and functions as the system 51 except that it may have multiple paths. The dispersing system 101 has the same structure and functions as the system 51 except that it supplies the mixture to the dispersing device 301 by means of compressive force. So, a duplicate explanation is omitted.

The dispersing system 91 as in FIG. 11 comprises the dispersing device 301, a first tank 92, a second tank 93, a first piping 94, and a second piping 95. Respective first and second tanks 92, 93 can store both the mixture to be supplied to the dispersing device 301 and the mixture after it is dispersed by the dispersing device 301. That is, each of the first and second tanks 92, 93 has functions of both the tank 52 for storing a mixture before the process and the tank 53 for storing a mixture after the process. Agitating mechanisms 92c, 93c that consist of motors 92a, 93a and agitating plates 92b, 93b are provided to the first and second tanks 92, 93, respectively, so as to have the functions of the agitators 52c, 53c.

In the first piping 94 piping for the mixture from a port 92d for discharging of the first tank 92 and piping for the mixture from a port 93d for discharging of the second tank 93 join to supply the mixture to the port 33 for supplying of the dispersing device 301. At the joined point a first selector valve 98 is provided to the first piping 94.

In the second piping 95 piping for supplying the mixture from the port 44 for discharging of the dispersing device 301 branches to supply the mixture to an inlet (a port for supplying) 92e of the first tank 92 and to an inlet (a port for supplying) 93e of the second tank 93. At the branch a second selector valve 99 is provided to the second piping 95.

A pump 96 is provided to the first piping 94. The pump 96 supplies the mixture in one of the first and second tanks 92, 93 that is connected by means of the first selector valve 98 to function as the tank for storing a mixture before the process to the dispersing device 301 (the port 33 for supplying the mixture of the device 301). A pump 97 is provided to the second piping 95. The pump 97 supplies the mixture in the container 11 of the dispersing device 301 to one of the first and second tanks 92, 93 that is connected by means of the second selector valve 99 to function as the tank for storing a mixture after the process.

Namely, by the dispersing system 91 the first and second selector valves 98, 99 are switched multiple times so that the mixture is supplied from either of the tanks 92, 93 through the first piping 94 to the dispersing device 301 to be dispersed and so that the mixture after being processed is supplied to the other tank. The dispersing system 91 enables a dispersing process in which the mixture passes between the rotor 2 and the stator 203 of the dispersing device 301 to be carried out multiple times, namely “in multiple dispersions.”

Like the dispersing system 51, the dispersing system 101 as in FIG. 13 comprises the dispersing device 301, a tank 52 for storing a mixture before the process, a tank 53 for storing a mixture after the process, a first piping 54, and a second piping 55. Like the dispersing system 51, a pump 57 is provided to the second piping 55.

A compressor 102 is connected to the tank 52 for storing a mixture before the process of the dispersing system 101 via a flow control valve 103 and a filter 104. Namely, the flow control valve 103 and the filter 104 are provided to a piping 105 that connects the tank 52 for storing a mixture before the process with the compressor 102. The flow control valve 103 regulates the flow of compressed air from the compressor 102 to the tank 52. The filter 104 removes unwanted substances from the compressed air that is supplied from the compressor 102 to the tank 52.

By the dispersing system 101, a pressure applied by the compressor 102 and the flow control valve 103 on the mixture in the tank 52 for storing a mixture before the process causes the mixture to flow from the tank 52 through the first piping 54 to the dispersing device 301.

By the dispersing system 101, the mixture that has been stored in the tank 52 for storing a mixture before the process is dispersed by the dispersing device 301 and the mixture after being dispersed is supplied to the tank 53 for storing a mixture after the process. Thus the mixture is dispersed. The dispersing system 101 is suitable for a dispersing process “in a single dispersion.”

As discussed above, since both the dispersing system 91 and the dispersing system 101 include the dispersing device 301, the yield is good, the dispersing power is strong, and the dispersing process can be carried out within an appropriate temperature range. Namely, an appropriate dispersing process can be carried out. Further, while the bearing is protected an appropriate dispersing process can be carried out with an appropriate amount of the unprocessed mixture to be supplied and with an appropriate dispersing rate. Incidentally, the dispersing device 301 may constitute a circulating-type dispersing system with a pump for circulation, a piping for circulation, and a tank that is provided to the piping.

The basic Japanese patent application, No. 2014-237740, filed Nov. 25, 2014, is hereby incorporated by reference in their entireties in the present application.

The present invention will become more fully understood from the detailed description. However, the detailed description and the specific embodiments are only illustrations of the desired embodiments of the present invention, and so are given only for an explanation. Various possible changes and modifications will be apparent to those of ordinary skill in the art on the basis of the detailed description.

The applicant has no intention to dedicate to the public any disclosed embodiment. Among the disclosed changes and modifications, those which may not literally fall within the scope of the present claims constitute, therefore, a part of the present invention in the sense of the doctrine of equivalents.

The use of the articles “a,” “an,” and “the” and similar referents in the specification and claims are to be construed to cover both the singular and the plural form of a noun, unless otherwise indicated herein or clearly contradicted by the context. The use of any and all examples, or exemplary language (e.g., “such as”) provided herein is intended merely to better illuminate the invention, and so does not limit the scope of the invention, unless otherwise stated.

### EXPLANATION OF MAIN NUMERALS

1 the dispersing device
2 the rotor
3 the stator
11 the container
12 the cover assembly
50 the groove

1. A shear-type dispersing device for dispersing a mixture of a slurry or a liquid by causing the mixture to flow by centrifugal force toward an outer circumference between a rotor, and a stator that is disposed to face the rotor, comprising:
a container for receiving the dispersed mixture;
a cover assembly that closes an upper opening of the container;
a stator that is fixed under the cover assembly;
a rotor that is disposed to face a lower surface of the stator; and
an assembly for supplying the mixture that stores an unprocessed mixture to be supplied to a gap between the rotor and the stator;
wherein the assembly for supplying the mixture has:
a body for storing the mixture;
a first member for injecting the mixture that injects the mixture in the body to a supply route, to thereby supply the mixture to the gap between the rotor and the stator; and
a second member for injecting the mixture that is disposed to protrude from a plane for pressing of the first member for injecting the mixture, and that injects the mixture in the supply route to supply the mixture to the gap between the rotor and the stator.

2. The dispersing device of claim 1, wherein in the stator a hole for inserting the rotary shaft is formed, and
wherein the mixture is supplied from outside the hole for inserting the rotary shaft to the gap between the stator and the rotor.

3. The dispersing device of claim 2, wherein the cover assembly has a part for holding the stator,
wherein in the stator a through-hole for supplying the mixture is formed outside the hole for inserting the rotary shaft,
wherein in the part for holding the stator a passage is formed to connect a port for supplying the mixture, which is formed in the part for holding the stator, with the through-hole for supplying the mixture that is formed in the stator,
wherein at least the passage constitutes the supply route, and
wherein the mixture that is supplied from the port for supplying the mixture is supplied to the gap between the stator and the rotor through the passage in the part for holding the stator and the through-hole in the stator.

4. The dispersing device of claim 3, wherein a circular groove is formed concentrically with the rotor on a surface of the rotor, which faces the stator, the groove being located at a position that corresponds to the through-hole that is formed in the stator.

5. The dispersing device of claim 4, wherein the mixture that is supplied through the through-hole is highly viscous or has a high concentration of solids.

6. The dispersing device of claim 4, wherein a depth of the groove is greater than the gap between the stator and a part of the surface of the rotor on which no groove is formed

7. The dispersing device of claim 6, wherein the depth of the groove is greater than the gap between the stator and a part of the surface of the rotor on which no groove is formed so that the mixture is supplied from the through-hole to the gap by means of centrifugal force that is generated by the rotation of the rotor.

8. The dispersing device of claim 4, wherein a shape of the groove is a wide inverted trapezoid in a cross section along a direction of a radius of the rotor, and
wherein a width at an upper side of the groove in the cross section is greater than a length of a lower end of the through-hole in a direction of a radius of the rotor.

9. The dispersing device of claim 3, wherein the assembly for supplying the mixture has
a second port for supplying the mixture that is connected to the port for supplying the mixture of the part for holding the stator and
a second passage that supplies the mixture in the body to the passage of the part for holding the stator,
wherein the assembly for supplying the mixture is integrated with the part for holding the stator by attaching the second port for supplying the mixture to the port for supplying the mixture, and when the assembly is integrated with the part for holding the stator the second passage communicates with the passage, and
wherein the passage and the second passage constitute the supply route.

10. The dispersing device of claim 3, further comprising:
a rotary shaft that rotates the rotor; and
a bearing that is disposed in the cover assembly and is located above the stator to rotatably hold the rotary shaft;
wherein the cover assembly has a part for holding the bearing,
wherein the part for holding the stator is disposed under the part for holding the bearing,
wherein a first vent-hole for supplying gas to the hole for inserting the rotary shaft of the stator is formed in the part for holding the stator,
wherein a second hole for inserting the rotary shaft is formed in the part for holding the stator,
wherein a second vent-hole for connecting to an outside of the part for holding the stator is formed in a space that is located under the part for holding the bearing and over the second hole for inserting the rotary shaft, and
wherein a pressure of gas that is supplied through the first vent-hole is higher than that in a space that is ventilated through the second vent-hole.

11. The dispersing device of claim 10, wherein a part for forming a space is formed in a part for inserting the rotary shaft of either or both of the stator and the part for holding the stator,
wherein the first vent-hole is configured to communicate with a space that is formed by the part for forming a space, and
wherein gas at a predetermined pressure is supplied to the hole for inserting the rotary shaft of the stator through the space.

12. The dispersing device of claim 11, wherein a third vent-hole for supplying gas to a space of the bearing on a side near the stator is formed in the part for holding the bearing, and
wherein a pressure of gas that is supplied through the third vent-hole is higher than, or equal to, that of gas that is supplied through the first vent-hole.

13. The dispersing device of claim 11, wherein a third vent-hole for supplying gas to a space of the bearing on a side near the stator is formed in the part for holding the bearing, and
wherein a pressure of gas that is supplied through the third vent-hole is higher than that in the space that is ventilated by the second vent-hole and is less than, or equal to, that of gas that is supplied through the first vent-hole.

14. The dispersing device of claim 11, further comprising:
a spacer that is detachably disposed between the rotary shaft and the rotor to adjust a gap between the rotor and the stator;
wherein when the spacer is disposed an axial position of the rotor in relation to the stator is fixed,
wherein the part for holding the bearing has a part for controlling an axial position that controls the axial position of the part for holding the stator by abutting the part for holding the stator by means of a second spacer, and
wherein the second spacer is detachably disposed between the part for holding the bearing and the part for holding the stator to adjust the axial position of the stator in relation to the part for holding the bearing by being replaced by another second spacer that has a different axial length.

15. The dispersing device of claim 11, wherein a concave part is formed on an upper surface of the rotor so that a lower end of the rotary shaft is inserted thereto,
wherein a through-hole opens on the concave part,
wherein the lower end of the rotary shaft is inserted into the concave part of the rotor so that a fastening member is fixed from a lower side of the rotor while the lower end abuts the concave part across the spacer,
wherein the fastening member fastens the rotary shaft to the rotor across the spacer by fixing a part thereof to the rotary shaft through the through-hole in the rotor,
wherein pins are inserted into the concave part of the rotor and the lower end of the rotary shaft to transmit a rotational power of the rotary shaft to the rotor, the pins being disposed at uniform intervals along a circumferential direction, and
wherein a first through-hole through which the fastening member passes and second through-holes through which the pins pass are formed in the spacer.

16. The dispersing device of claim 11, wherein the stator is bigger than the rotor on a plane where the stator faces the rotor,
wherein in the stator a groove for cooling is formed on a surface opposite the surface that faces the rotor, and
wherein the groove for cooling is formed beyond an outer edge of the rotor.

17. The dispersing device of claim 11, wherein a wall is formed along a radial direction on the groove for cooling,
wherein a port for supplying coolant and a port for discharging the coolant are disposed across the wall, and
wherein the coolant that is supplied from the port for supplying the coolant flows toward a direction in which no wall is formed near the port for supplying the coolant, in the circumferential direction, the coolant being discharged from the port for discharging the coolant.

18. A shear-type dispersing device for dispersing a mixture of a slurry or a liquid by causing the mixture to flow by centrifugal force toward an outer circumference between a rotor, and a stator that is disposed to face the rotor, comprising:
a container for receiving the dispersed mixture;
a cover assembly that closes an upper opening of the container; and
a stator that is fixed under the cover assembly;
wherein in the stator a hole for inserting the rotary shaft is formed and a through-hole for supplying the mixture is formed outside of the through-hole,
wherein the mixture is supplied to a gap between the stator and the rotor through the through-hole of the stator,
wherein a circular groove is formed concentrically with the rotor on a surface of the rotor, which faces the stator, the groove being located at a position that corresponds to the through-hole that is formed in the stator.

19. A shear-type dispersing device for dispersing a mixture of a slurry or a liquid by causing the mixture to flow by centrifugal force toward an outer circumference between a rotor, and a stator that is disposed to face the rotor, comprising:
a container for receiving the dispersed mixture;
a cover assembly that closes an upper opening of the container;
a stator that is fixed under the cover assembly;
a rotor that is disposed to face a lower surface of the stator;
a rotary shaft that rotates the rotor; and
a bearing that is disposed in the cover assembly and is located above the stator to rotatably hold the rotary shaft;
wherein the cover assembly has a part for holding the bearing and a part for holding the stator that is disposed under the part for holding the bearing,
wherein a first vent-hole for supplying gas to the hole for inserting the rotary shaft of the stator is formed in the part for holding the stator,
wherein a second hole for inserting the rotary shaft is formed in the part for holding the stator,
wherein a second vent-hole for communicating outside the part for holding the stator is formed in a space that is located under the part for holding the bearing and over the second hole for inserting the rotary shaft, and
wherein a pressure of gas that is supplied through the first vent-hole is higher than that in a space that is ventilated through the second vent-hole.

20. A process for dispersing that uses the dispersing device of claim 1, comprising:
a step of supplying the mixture between the rotor and the stator of the dispersing device so as to cause the mixture to flow toward an outer circumference by centrifugal force.
